(19) United States
(12) Patent Application Publication
(10) Pub. No.: US 2025/0091008 A1
(43) Pub. Date: Mar. 20, 2025

(54) DESALINATION AND COOLING SYSTEM INTEGRATING DIRECT CONTACT MEMBRANE DISTILLATION AND EJECTOR COOLING CYCLE

(71) Applicant: KING FAHD UNIVERSITY OF PETROLEUM AND MINERALS, Dhahran (SA)

(72) Inventors: Dahiru Umar LAWAL, Dhahran (SA); Binash IMTEYAZ, Dhahran (SA); Isam Hassan ALJUNDI, Dhahran (SA); Mohamed Abdelkarim ANTAR, Dhahran (SA)

(73) Assignee: KING FAHD UNIVERSITY OF PETROLEUM AND MINERALS, Dhahran (SA)

(21) Appl. No.: 18/469,206

(22) Filed: Sep. 18, 2023

(51) Int. Cl. B01D 61/36; C02F 1/44; C02F 103/08; F25B 1/06

(52) U.S. Cl. CPC B01D 61/368; B01D 61/3641; B01D 61/366; C02F 1/447; F25B 1/06; B01D 2311/06; B01D 2313/221; B01D 2313/367; C02F 2103/08; C02F 2201/009; C02F 2301/08; C02F 2303/10

(57) ABSTRACT

A desalination and cooling system is disclosed, integrating an Ejector Cooling Cycle (ECC) system and a Direct Contact Membrane Distillation (DCMD) system. The ECC system includes a generator, an evaporator, an ejector, and a condenser. The generator produces a primary flow of refrigerant, the evaporator provides cooling and a secondary flow of the refrigerant, and the ejector combines these flows to generate a super-heated stream of the refrigerant, which the condenser cools. The DCMD system, including a feed chamber, a permeate chamber, a membrane with pores, and an external cooling source, allows water vapors from a hot stream to pass from the feed chamber to the permeate chamber. The ECC and DCMD systems are connected at the condenser, where the super-heated stream of the refrigerant heats the cold stream to produce the hot stream, facilitating efficient desalination and cooling.

### CROSS REFERENCE TO RELATED APPLICATIONS

Aspects of the present disclosure are described in Applicant's co-pending patent applications titled “DESALINATION AND COOLING SYSTEM INTEGRATING PERMEATE GAP MEMBRANE DISTILLATION AND EJECTOR COOLING CYCLE” (Attorney Docket No.: 548519US), “DESALINATION AND COOLING SYSTEM INTEGRATING VACUUM MEMBRANE DISTILLATION AND EJECTOR COOLING CYCLE” (Attorney Docket No.: 548521US), “DESALINATION AND COOLING SYSTEM INTEGRATING SWEEPING GAS MEMBRANE DISTILLATION AND EJECTOR COOLING CYCLE” (Attorney Docket No.: 548524US), and “DESALINATION AND COOLING SYSTEM INTEGRATING AIR GAP MEMBRANE DISTILLATION AND EJECTOR COOLING CYCLE” (Attorney Docket No.: 548525US), all of which are incorporated herein by reference in their entirety.

### BACKGROUND

### Technical Field

The present disclosure is directed to the field of desalination and cooling technologies. More specifically, the present disclosure relates to a desalination and cooling system integrating a Direct Contact Membrane Distillation (DCMD) system and an Ejector Cooling Cycle (ECC) system for efficient concurrent and simultaneous desalination and cooling.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Water scarcity is one of the most pressing challenges of our time, driven by factors such as population growth, urbanization, and climate change. As freshwater resources become increasingly scarce, societies around the world are seeking sustainable and efficient methods to secure reliable water supplies. Desalination, which is the process of removing salts and other minerals from sea water or brackish water, has emerged as a critical technology to augment freshwater resources.

However, traditional desalination techniques such as reverse osmosis and thermal distillation often come with substantial energy cost, significant environmental impact, and in some cases, produce brine by-products that pose disposal challenges. As a result, there has been an increasing interest in developing more energy-efficient, environmentally friendly, and cost-effective desalination technologies. One promising approach is Membrane Distillation (MD), a thermal desalination process that leverages a selective membrane to separate salts and other contaminants from water.

Among various MD configurations, Direct Contact Membrane Distillation (DCMD) has shown promising performance. In DCMD, a hot feed stream chamber and a cold clean water chamber are separated by a hydrophobic membrane. The vapor pressure difference between the hot feed stream and the cold distillate stream of the cold clean water chamber across the membrane causes water vapor of the hot feed stream to travel through the membrane pores, and condense directly in a clean cold stream flowing on the other side of the membrane, producing clean water. The larger the temperature difference between the feed and permeate sides, the higher the vapor pressure difference, leading to increased water flux across the membrane.

In addition to desalination, there is also a growing demand for energy-efficient cooling technologies. Cooling is essential for various applications, including air conditioning, refrigeration, and industrial processes. Conventional cooling technologies, such as vapor compression refrigeration, are energy-intensive and use refrigerants that can have a high global warming potential. Therefore, there is a need for more energy-efficient, environmentally friendly cooling technologies.

One such technology is Ejector Cooling Cycle (ECC), which is a type of refrigeration cycle that uses a jet of vapor to entrain and compress additional vapor, eliminating the need for a mechanical compressor. The ECC is less energy-intensive compared to traditional vapor compression refrigeration and can operate with a variety of refrigerants, including environmentally friendly options. However, like all refrigeration cycles, ECC produces waste heat that is typically released into the environment.

Therefore, the search for efficient, sustainable, and cost-effective desalination technology as well as cooling technology is a pressing issue in the context of water scarcity and energy efficiency. There are existing technologies in both areas, each with its strengths and weaknesses. The challenge lies in overcoming their limitations and finding innovative ways to enhance their performance and make them more suitable for widespread application.

CN110342600A discloses an ejector-driven membrane distillation system. A distillation membrane divides a membrane module into a raw material side and a fraction side. The raw material is heated by a hot stream produced by an ejector so that some water molecules in the raw material pass through the distillation membrane and enter the fraction side to form a steam, which then flows into the ejector. Despite having an ejector and a membrane, there is no closed ejector cooling cycle because fresh water is produced by condensing the hot stream exiting the ejector. Therefore, the refrigerant for the ejector is water alone, which has to be constantly supplied to the ejector. This reference does not teach direct contact membrane distillation.

CN201209974Y discloses a system including a generator, a condenser, an evaporator, an absorber, a solution heat exchanger, and a membrane distillation mass transfer exchanger (e.g. a direct contact membrane distillation (DCMD) system). There is no ejector. Additionally, water vapors collected by the DCMD system are the feed steam of the generator. That is, the DCMD system is not used for water desalination but part of a refrigeration cycle. Therefore, this reference does not fulfill the need for an efficient and sustainable desalination and cooling system.

U.S. Ser. No. 10/899,635B2 discloses an ejector cooling cycle (ECC) system. Sea water is used as a secondary flow into the ejector to obtain high pressure vapors which are then cooled by the condenser to obtain purified water. However, there is no membrane distillation. Further, the ECC system is not closed but open.

KR1683392B1 discloses an ejector type desalination system. Sea water is injected into the evaporator to produce a secondary flow for the ejector which is then cooled by the condenser to obtain purified water. However, there is no membrane distillation.

CN109942137B discloses a cogeneration system including an ammonia absorption refrigeration system and a membrane distillation system. The ammonia absorption refrigeration system includes a rectification tower, a condenser, a sub cooler and an evaporator but is not an ECC system.

Koirala et al. (“Performance Analysis of an Eductor-Based Membrane Distillation Unit”) discloses an eductor-based membrane distillation process including direct contact membrane distillation (DCMD) and vacuum membrane distillation (VMD). The water vapors collected by DCMD or VMD are injected into the eductor to condense into liquid water. However, an eductor is not the same as an ejector.

Each of the aforementioned references suffers from one or more drawbacks hindering their adoption. Accordingly, it is one object of the present disclosure to provide a desalination and cooling system integrating DCMD and ECC to enhance the energy efficiency, environmental performance, and cost-effectiveness of desalination and cooling technologies.

### SUMMARY

In an exemplary embodiment, a desalination and cooling system is provided. The desalination and cooling system includes an ejector cooling cycle (ECC) system. The ECC system includes a generator configured to generate a primary flow of a refrigerant. The ECC system also includes an evaporator configured to provide cooling and provide a secondary flow of the refrigerant. The ECC system further includes an ejector configured for the primary flow and the secondary flow to pass through to obtain a super-heated stream of the refrigerant. The ECC system further includes a condenser configured to cool the super-heated stream of the refrigerant. The desalination and cooling system also includes a direct contact membrane distillation (DCMD) system. The DCMD system includes a feed chamber configured to receive a feed stream comprising water. The DCMD system also includes a permeate chamber configured to receive water permeate. The DCMD system further includes a membrane disposed between the feed chamber and the permeate chamber. The membrane disposed between the feed chamber and the permeate chamber, the membrane configured to be in direct contact with the feed stream and the water permeate on opposing sides. The membrane further includes a plurality of pores configured to allow water vapors originating from the feed stream to pass from the feed chamber through the membrane to the permeate chamber. The ECC system and the DCMD system are connected at the condenser so that the feed stream is heated by the super-heated stream of the refrigerant at the condenser, before entering the feed chamber.

In some embodiments, the DCMD system further includes a clean water chamber that is configured to receive permeated water vapors from the permeate chamber.

In some embodiments, the evaporator is configured to provide cooling for the clean water chamber to condense the permeated water vapors therein.

In some embodiments, the DCMD system further includes an external cooling source that is configured to provide cooling for the clean water chamber to condense the permeated water vapors therein.

In some embodiments, an outlet of the clean water chamber is connected to an inlet of the condenser so that the clean water chamber is configured to be cooled by the feed stream to condense the permeated water vapors while pre-heating the feed stream before the feed stream enters the condenser.

In some embodiments, the ECC system further includes a heater that is configured to provide heat for the generator to generate the primary flow of the refrigerant.

In some embodiments, the heater is configured to further heat the feed stream after the condenser and before the feed chamber.

In some embodiments, the ECC system further includes a heater that is configured to further heat the super-heated stream of the refrigerant before the super-heated stream of the refrigerant enters the condenser.

In some embodiments, the DCMD system is a multi-effect distillation system.

In some embodiments, the ECC system further includes a solar collector that is configured to provide heat for the generator to generate the primary flow of the refrigerant.

In another exemplary embodiment, a desalination and cooling system is provided. The desalination and cooling system includes an ejector cooling cycle (ECC) system. The ECC system includes a generator configured to generate a primary flow of a refrigerant. The ECC system also includes an evaporator configured to provide cooling and provide a secondary flow of the refrigerant. The ECC system further includes an ejector configured for the primary flow and the secondary flow to pass through to obtain a super-heated stream of the refrigerant. The ECC system further includes an ejector configured for the primary flow and the secondary flow to pass through to obtain a super-heated stream of the refrigerant. The ECC system further includes a condenser configured to cool the super-heated stream of the refrigerant, the condenser comprising a wall separating a hot medium compartment and a cold medium compartment, the hot medium compartment configured to receive the super-heated stream of the refrigerant. The desalination and cooling system also includes a direct contact membrane distillation (DCMD) system. The DCMD system includes a permeate chamber configured to receive water permeate. The DCMD system has the cold medium compartment of the condenser of the ECC system configured to receive the feed stream including water. The DCMD system also includes the membrane disposed between the cold medium compartment and the permeate chamber. The membrane is configured to be in direct contact with the feed stream and the water permeate on opposing sides. The membrane includes a plurality of pores configured to allow water vapors to pass from the cold medium compartment through the membrane to the permeate chamber. The ECC system and the DCMD system are connected at the condenser so that the feed stream, in the cold medium compartment of the condenser, is heated by the super-heated stream of the refrigerant to generate the water vapors.

In some embodiments, the desalination and cooling system further includes an enclosure that houses the hot medium compartment, the cold medium compartment, the membrane and the permeate chamber.

In some embodiments, the hot medium compartment, the cold medium compartment, the membrane and the permeate chamber are arranged in succession in the enclosure.

In some embodiments, the generator, the ejector, and the condenser are configured to define a power cycle of the ECC system. Further, the evaporator, the ejector and the condenser are configured to define a refrigeration cycle of the ECC system.

In some embodiments, the DCMD system further includes a clean water chamber that is configured to receive permeated water vapors from the permeate chamber.

In some embodiments, the evaporator is configured to provide cooling for the clean water chamber to condense the permeated water vapors therein.

In some embodiments, the DCMD system further comprises an external cooling source that is configured to provide cooling for the clean water chamber to condense the permeated water vapors therein.

In some embodiments, an outlet of the clean water chamber is connected to an inlet of the condenser so that the clean water chamber is configured to be cooled by the feed stream to condense the permeated water vapors while pre-heating the feed stream before the feed stream enters the condenser.

In some embodiments, the ECC system further the ECC system further includes a heater that is configured to provide heat for the generator to generate the primary flow of the refrigerant.

In some embodiments, the coolant chamber, the permeate chamber, the membrane, the cold medium compartment, and the hot medium compartment are cylindrical and concentrical and are arranged in succession along a radial direction.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of a desalination and cooling system integrating an ejector cooling cycle (ECC) system and a direct contact membrane distillation (DCMD) system, according to certain embodiments;

FIG. 2 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop, the ECC condenser heats the feed stream, and ECC cooling effect is partly utilized for cooling the permeate stream, according to certain embodiments;

FIG. 3 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop, the intake feed water is pre-heated by the warm permeate from the permeate tank, and the ECC condenser further heats the feed stream, according to certain embodiments;

FIG. 4 is a schematic diagram of a desalination and cooling system having a multi-effect configuration, and integrating an ejector cooling cycle (ECC) system and a direct contact membrane distillation (DCMD) system, where a feed stream to be treated is fluidly connected in an open loop, and the waste heat from the condenser is employed to heat up the feed stream entering the DCMD, according to certain embodiments;

FIG. 5 is a schematic diagram of a desalination and cooling system having a multi-effect configuration, and integrating an ejector cooling cycle (ECC) system and a direct contact membrane distillation (DCMD) system, where a feed stream to be treated is fluidly connected in an open loop, the ECC condenser pre-heats the feed stream, and the feed stream is further heated by the source heat entering the generator according to certain embodiments;

FIG. 6 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop, the ECC condenser pre-heats the feed stream, the source heat entering the generator provide the additional heats to the feed stream, and the ECC cooling effect is partly utilized for cooling the permeate stream, according to certain embodiments;

FIG. 7 is a schematic diagram of a desalination and cooling system having a single-effect configuration, and integrating an ejector cooling cycle (ECC) system and a direct contact membrane distillation (DCMD) system, where the intake feed water is pre-heated by the warm permeate from the permeate tank, the ECC condenser further pre-heats the feed stream, and the source heat entering the generator provides the additional heats to the feed stream, according to certain embodiments;

FIG. 8 is a schematic diagram of a desalination and cooling system having a multi-effect configuration and integrating an ejector cooling cycle (ECC) system and a direct contact membrane distillation (DCMD) system, where the waste heat from the condenser is employed to pre-heat the intake feed stream. The heat source entering the generator heats up the feed stream to the maximum temperature before the feed stream enters the DCMD, according to certain embodiments;

FIG. 9 is a schematic diagram of a desalination and cooling system having a multi-effect configuration, and integrating an ejector cooling cycle (ECC) system and a direct contact membrane distillation (DCMD) system, where a feed stream to be treated is fluidly connected in an open loop, where the ECC condenser pre-heats the feed stream, and the feed stream is further heated by the source heat exiting the generator, according to certain embodiments;

FIG. 10 is a schematic diagram of a desalination and cooling system having a single-effect configuration, and integrating an ejector cooling cycle (ECC) system and a direct contact membrane distillation DCMD) system, where a feed stream to be treated is fluidly connected in an open loop, where the ECC condenser pre-heats the feed stream, the source heat exiting the generator further heats the feed stream, and the ECC cooling effect is partly utilized for cooling the permeate stream, according to certain embodiments;

FIG. 11 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop, the intake feed water is pre-heated by the warm coolant/permeate from the permeate tank, the ECC condenser further pre-heats the feed stream, and the source heat exiting the generator provide the additional heats to the feed stream, according to certain embodiments;

FIG. 12 is a schematic diagram of a desalination and cooling system having a multi-effect configuration, and integrating an ejector cooling cycle (ECC) system and a direct contact membrane distillation (DCMD) system, where a feed stream to be treated is fluidly connected in an open loop, and in coolant heat exchanger, the feed stream intake is used for lowering the coolant temperature entering the DCMD, according to certain embodiments;

FIG. 13 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop the ECC condenser pre-heats the feed stream, and feed stream is further heated by the super-heated refrigerant exiting the ejector through heater according to certain embodiments;

FIG. 14 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop, the ECC condenser pre-heats the feed stream, the feed stream is further heated by the super-heated refrigerant exiting the ejector through heater, and the ECC cooling effect is partly utilized for cooling the coolant/permeate stream, according to certain embodiments;

FIG. 15 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop the intake feed water is pre-heated by the warm coolant/permeate from the permeate tank, the ECC condenser pre-heats the feed stream, and feed stream is further heated by the super-heated refrigerant exiting the ejector through heater according to certain embodiments;

FIG. 16 is a schematic diagram of a desalination and cooling system having a multi-effect configuration, and integrating an ejector cooling cycle (ECC) system and a direct contact membrane distillation (DCMD) system, where a feed stream to be treated is fluidly connected in an open loop, the intake feed water is pre-heated by the warm coolant/permeate from the permeate tank, the ECC condenser further pre-heats the feed stream, and feed stream is finally heated by the super-heated refrigerant exiting the ejector through heater, according to certain embodiments;

FIG. 17 is a schematic diagram of a desalination and cooling system having a multi-effect configuration, and integrating an ejector cooling cycle (ECC) system and a direct contact membrane distillation (DCMD) system, where a feed stream to be treated is fluidly connected in an open loop the feed stream is heated by the super-heated refrigerant exiting the ejector through heater according to certain embodiments;

FIG. 18 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop, the feed stream is further heated by the super-heated refrigerant exiting the ejector through heater, and the ECC cooling effect is partly utilized for cooling the coolant/permeate stream, according to certain embodiments;

FIG. 19 is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop the intake feed water is pre-heated by the warm permeate from the permeate tank, and the feed stream is further heated by the super-heated refrigerant exiting the ejector through heater according to certain embodiments;

FIG. 20 is a schematic diagram of a desalination and cooling system having a multi-effect configuration, and integrating an ejector cooling cycle (ECC) system and a direct contact membrane distillation (DCMD) system, where a feed stream to be treated is fluidly connected in an open loop, the feed stream intake is used for lowering the coolant temperature entering the DCMD, and the feed stream is pre-heated in the process, according to certain embodiments;

FIG. 21 is a schematic diagram of a desalination and cooling system having a single-effect configuration and integrating an ejector cooling cycle (ECC) system and a direct contact membrane distillation (DCMD) system, where a feed stream to be treated is fluidly connected in an open loop, there is direct contact between the ECC condenser and MD feed chamber for direct heating of the feed stream according to certain embodiments;

FIG. 22A is a schematic diagram of a desalination and cooling system having a single-effect configuration, and integrating an ejector cooling cycle (ECC) system and a direct contact membrane distillation (DCMD) system, where a feed stream to be treated is fluidly connected in an open loop, a coolant chamber of the DCMD system pre-heats the feed stream, and a condenser of the ECC system having a hot medium compartment and a cold medium compartment, with the cold medium compartment receiving the feed stream from the coolant chamber and heating the feed stream in the DCMD system, according to certain embodiments;

FIG. 22B is a cross-section diagram of the DCMD system of FIG. 22A, according to certain embodiments;

FIG. 22C is a cross-section diagram of the DCMD system of FIG. 22A, according to alternate embodiments;

FIG. 22D is a schematic diagram of a desalination and cooling system having a single-effect configuration, and integrating an ejector cooling cycle (ECC) system and a direct contact membrane distillation (DCMD) system, according to certain embodiments;

FIG. 23A is a graph representing gained output ratio (GOR) performance of the desalination and cooling system of FIG. 1 at different temperatures of a generator of the ECC system therein;

FIG. 23B is a graph representing energy utilization factor (EUF) performance of the desalination and cooling system of FIG. 1 at different temperatures of a generator of the ECC system therein;

FIG. 23C is a graph representing freshwater productivity performance of the desalination and cooling system of FIG. 1 at different temperatures of a generator of the ECC system therein;

FIG. 23D is a graph representing cooling effect performance of the desalination and cooling system of FIG. 1 at different temperatures of a generator of the ECC system therein;

FIG. 24A is a graph representing gained output ratio (GOR) performance of the desalination and cooling system of FIG. 1 at different temperatures of an evaporator of the ECC system therein;

FIG. 24B is a graph representing energy utilization factor (EUF) performance of the desalination and cooling system of FIG. 1 at different temperatures of an evaporator of the ECC system therein;

FIG. 24C is a graph representing freshwater productivity performance of the desalination and cooling system of FIG. 1 at different temperatures of an evaporator of the ECC system therein;

FIG. 24D is a graph representing cooling effect performance of the desalination and cooling system of FIG. 1 at different temperatures of an evaporator of the ECC system therein;

FIG. 25A is a graph representing gained output ratio (GOR) performance of the desalination and cooling system of FIG. 1 at different temperatures of a condenser of the ECC system therein;

FIG. 25B is a graph representing energy utilization factor (EUF) performance of the desalination and cooling system of FIG. 1 at different temperatures of a condenser of the ECC system therein;

FIG. 25C is a graph representing freshwater productivity performance of the desalination and cooling system of FIG. 1 at different temperatures of a condenser of the ECC system therein;

FIG. 25D is a graph representing cooling effect performance of the desalination and cooling system of FIG. 1 at different temperatures of a condenser of the ECC system therein;

FIG. 26A is a graph representing gained output ratio (GOR) performance of the desalination and cooling system of FIG. 1 at different module length;

FIG. 26B is a graph representing energy utilization factor (EUF) performance of the desalination and cooling system of FIG. 1 at different module length;

FIG. 26C is a graph representing freshwater productivity performance of the desalination and cooling system of FIG. 1 at different module length;

FIG. 26D is a graph representing cooling effect performance of the desalination and cooling system of FIG. 1 at different module length;

FIG. 26E is a graph representing variation in membrane area of the desalination and cooling system of FIG. 1 at different module length;

FIG. 27A is a graph representing gained output ratio (GOR) performance of the desalination ad cooling system of FIG. 1 at different feed stream temperature;

FIG. 27B is a graph representing energy utilization factor (EUF) performance of the desalination and cooling system of FIG. 1 at feed stream temperature;

FIG. 27C is a graph representing freshwater productivity performance of the desalination and cooling system of FIG. 1 at different feed stream temperature;

FIG. 27D is a graph representing cooling effect performance of the desalination and cooling system of FIG. 1 at different feed stream temperature;

FIG. 28A is a graph representing gained output ratio (GOR) performance of the desalination and cooling system of FIG. 1 at different flow rates of feed stream therein;

FIG. 28B is a graph representing energy utilization factor (EUF) performance of the desalination and cooling system of FIG. 1 at different flow rates of feed stream therein;

FIG. 28C is a graph representing freshwater productivity performance of the desalination and cooling system of FIG. 1 at different flow rates of feed stream therein; and

FIG. 28D is a graph representing cooling effect performance of the desalination and cooling system of FIG. 1 at different flow rates of feed stream therein.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a desalination and cooling system which integrates an ejector cooling cycle (ECC) system and a direct contact membrane distillation (DCMD) system (the desalination and cooling system is interchangeably referred to as an “integrated system” without any limitations), utilizing the waste heat from the ECC system to heat a feed stream (e.g. saline water) in the DCMD system. This innovative approach offers several benefits. First, it enhances the overall energy efficiency of the integrated system by capturing and reusing waste heat that would otherwise be lost. Second, it potentially reduces the cost of the process by combining two operations into the integrated system, saving on equipment and operational costs. Third, by leveraging cooling capabilities of the ECC system, the integrated system can also provide cooling facilities in addition to desalination, making it particularly suitable for applications in warm climates where both clean water and cooling are in high demand.

Although the desalination and cooling system, integrating the ECC system and the DCMD system, shows great promise, it also poses new challenges. The integrated system needs to be carefully designed to ensure the efficient transfer of heat from the ECC process to the DCMD process. For instance, the design considerations include configurations of feed chamber and permeate chamber in the DCMD system, the use of heat exchangers for effective heat transfer between the ECC system and DCMD system, and the control of various operating parameters. The present disclosure addresses these challenges and presents novel designs for the desalination and cooling system integrating the ECC system and the DCMD system, as discussed hereinafter.

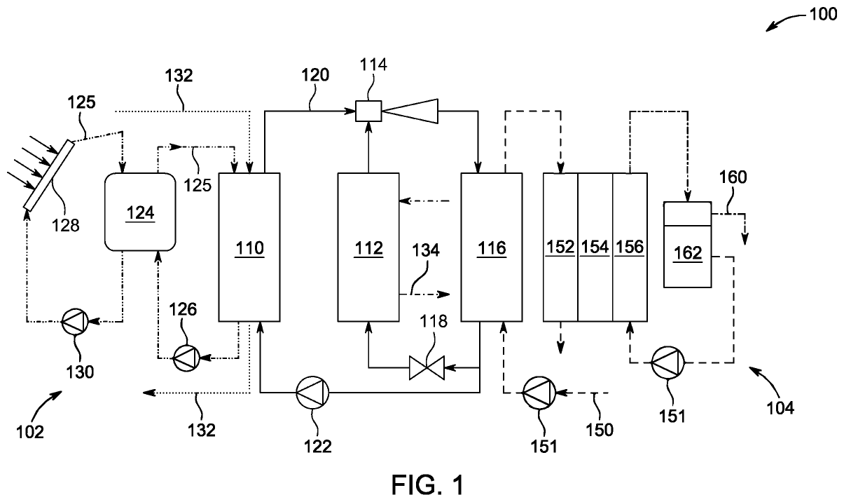

Referring to FIG. 1, illustrated is a desalination and cooling system 100 that integrates an Ejector Cooling Cycle (ECC) system 102 and a Direct Contact Membrane Distillation (DCMD) system 104. The desalination and cooling system 100 utilizes and combines principles of thermodynamic cycles and heat and mass transfer to create a looped system that provides cooling effect via the ECC system 102 and also produces desalinated water via the DCMD system 104. In particular, the ECC system 102 is responsible for the thermal management process, and operates based on the principles of thermodynamics, utilizing a refrigerant to absorb, transfer, and release heat in a cyclic manner. On the other hand, the DCMD system 104 is responsible for the desalination process and operates based on the principles of heat and mass transfer. Thereby, the desalination and cooling system 100 of the present disclosure provides solutions for water desalination and thermal management by integrating the functionalities and leveraging the synergies of the ECC system 102 and the DCMD system 104, to enhance energy efficiency and productivity.

As illustrated, the ECC system 102 includes a generator 110, an evaporator 112, an ejector 114, a condenser 116, and a throttle valve 118. Herein, the ECC system 102 uses a refrigerant 120 (with flow of the refrigerant 120 being shown by solid lines in FIG. 1) to perform a cooling cycle. The generator 110 is configured to generate a primary flow of the refrigerant 120. The evaporator 112 provides cooling and creates a secondary flow of the refrigerant 120. The primary and secondary flows of the refrigerant 120 pass through the ejector 114 to obtain a super-heated stream of the refrigerant 120. The condenser 116 cools the super-heated stream of the refrigerant 120. The super-heated stream of the refrigerant 120, after being cooled in the condenser 116, releases a significant amount of latent heat, which may be utilized. As shown, a first pump 122 may be placed between the condenser 116 and the generator 110, which aids in circulating the cooled refrigerant 120 from the condenser 116 back to the generator 110.

Herein, the generator 110, the evaporator 112, and the condenser 116 (and also a heater and a heat exchanger as would be discussed later) may each include a heat exchanger of any suitable types which may include, but not limited to, plate heat exchangers, tube in tube heat exchangers, shell and tube heat exchangers, plate and shell heat exchangers, plate fin heat exchangers, double tube heat exchangers, adiabatic wheel heat exchangers, finned tube heat exchangers and other heat exchanger variants.

In some examples, the ECC system 102 may also include additional components. A storage tank 124 may also be part of the ECC system 102 to store a heat exchange fluid (not shown), such as water. A second pump 126 may also be added between the generator 110 and the storage tank 124. The second pump 126 may facilitate circulation of the heat exchange fluid between the generator 110 and the storage tank 124. The storage tank 124 provides a stream 125 of heat exchange fluid to the generator 110, if need be. In some examples, a solar collector 128, or some other renewable energy sources, may be added to the ECC system 102 for providing energy for operations thereof. Further, a third pump 130 may be added between the storage tank 124 and the solar collector 128, helping to circulate the heat exchange fluid between these two components. Herein, the solar collector 128 may harness solar energy to heat the heat exchange fluid, which may then be stored in the storage tank 124 to be circulated to the generator 110 for heating the refrigerant 120 therein. Thereby, the solar collector 128 is configured to provide heat for the generator 110 to generate the primary flow of the refrigerant 120.

Furthermore, in some examples, the generator 110 may utilize waste heat 132 (as represented by dotted lines) from an external source for heating the refrigerant therein. These external sources may vary depending on an application and/or a location of the operation of the ECC system 102. Some potential external sources of waste heat include, but not limited to, industrial processes, power generation facilities, data centers, etc. The waste heat supplied to the generator 110 heats the refrigerant 120 (along with heat from the heat exchange fluid 125), causing the refrigerant 120 to evaporate and create a high-pressure gas. The remaining waste heat in the generator 110 may be exhausted out or be utilized for some other heating purposes in the desalination and cooling system 100 without any limitations.

In the ECC system 102, the generator 110, the ejector 114, and the condenser 116 are configured to define a power cycle. In the power cycle, the primary flow of the refrigerant 120 is generated in the generator 110 and then directed to the ejector 114. The primary flow of the refrigerant 120 drives the operation of the ejector 114, which also receives the secondary flow of the refrigerant 120 from the evaporator 112. The primary and secondary flows of the refrigerant 120 mix in the ejector 114 to produce the super-heated stream of the refrigerant 120, which then enters the condenser 116. The condenser 116 cools the super-heated stream of the refrigerant 120, releasing heat that is transferred to the feed stream 150 in the DCMD system 104. This heat transfer elevates the temperature of the feed stream 150, promoting the distillation process in the DCMD system 104. Moreover, in the ECC system 102, the evaporator 112, the ejector 114, and the condenser 116 are configured to define a refrigeration cycle. In the refrigeration cycle, the evaporator 112 provides cooling and generates the secondary flow of the refrigerant 120. This secondary flow is directed to the ejector 114, where it mixes with the primary flow to form the super-heated stream of the refrigerant 120. After the condensation process in the condenser 116, the refrigerant 120 flows through the throttle valve 118 and returns to the evaporator 112 to provide a cooling effect 134, completing the refrigeration cycle. The cooling effect 134 produced in the evaporator 112 may be used for cooling and air conditioning applications or other appropriate applications, and/or to cool the incoming feed stream 150 or other parts of the desalination and cooling system 100 as required. By defining separate power and refrigeration cycles within the ECC system 102, the desalination and cooling system 100 may effectively manage the heat transfer and cooling processes to enhance the overall efficiency and productivity thereof.

The DCMD system 104, on the other hand, is responsible for the actual desalination process. The desalination and cooling system 100 is designed to treat a feed stream 150 (as represented by dashed lines), which may be pumped in via a feed pump 151, and that is fluidly connected in an open loop. The DCMD system 104 includes a feed chamber 152, a membrane 154, and a permeate chamber 156. Herein, the feed chamber 152 is configured to receive the feed stream 150 comprising water, usually, in a heated state (and thus also referred to as hot stream or hot feed stream, without any limitations) thereof. The permeate chamber 156 is configured to receive water vapors from the feed stream 150 comprising water. The membrane 154, which includes a plurality of pores, is disposed between the feed chamber 152 and the permeate chamber 156. Herein, the membrane 154 may include any one of a composite membrane, a nano-composite membrane, a hydrophobic membrane, an omni phobic membrane, a hydrophilic and hydrophobic composite dual layer membrane, a modified ceramic membrane, a porous ceramic membrane, a surface modified membrane, a polymer electrolyte membrane, a porous graphene membrane, or a polymeric membrane, and a contact angle of a droplet of the feed stream 150 on the membrane 154 is at least 90 degrees. The membrane 154 is hydrophobic so that surface tension prevents liquid water and salts contained in the liquid water from entering the pores of the membrane 158 while allowing water vapor to pass through. In some examples, the DCMD system 104 further includes an external cooling source 162.

Herein, the hot feed stream 150 in the feed chamber 152 flows over the surface of the membrane 154, where water vapor is generated at the membrane-feed water interface. The pores in the membrane 154 allow water vapors originating from the hot feed stream 150 to pass from the feed chamber 152 through the membrane 154 to the permeate chamber 156. Specifically, the membrane 154, with its selective permeability, allows only water vapor to pass through, effectively separating the water from the other contaminants present in the feed stream 150. The driving force for vapor permeation across the membrane 154 is the partial pressure difference between the two sides of the membrane 154, as created by the temperature difference between the two sides of the membrane 154. The permeate stream emerges out of the permeate chamber 156 and directly condenses into liquid water at an external cooling source 162, by rejecting heat to the external cooling source 162 and the permeate chamber 156 forming freshwater 160. The freshwater 160 may then be drained or pumped out of the permeate chamber 156. Herein, the flow of the feed stream 150 in the compartments of the DCMD system 104 may be vertical, horizontal, or inclined, without any limitations. Further, the DCMD system 104 may be any one of a spiral wound configuration, a tubular membrane configuration, a hollow fiber membrane configuration, or a flat sheet (plate and frame) membrane configuration, without any limitations.

Now, specifically as illustrated in FIG. 1, the desalination and cooling system 100 of the present disclosure have the ECC system 102 and the DCMD system 104 connected at the condenser 116. In the desalination and cooling system 100, the feed stream 150 to be treated passes through the condenser 116, allowing the feed stream 150 to be heated by the super-heated stream of the refrigerant 120 at the condenser 116. This process results in the production of the feed stream 150. In general, in the desalination and cooling system 100 of the present disclosure, heat source and heat sink to the DCMD system 104 may be completely or partially provided by the ECC system 102, which acts as a heat pump. By using the waste heat from the ECC system 102 to pre-heat the feed stream 150, the desalination and cooling system 100 improves energy utilization and maximizes the overall productivity of the desalination and cooling process. Thereby, the desalination and cooling system 100 allows for efficient desalination and cooling processes by combining the functionalities of the ECC system 102 and the DCMD system 104.

Further, as illustrated, the desalination and cooling system 100 has the feed stream 150 to be treated fluidly connected in an open loop, which may offer certain advantages in terms of operational flexibility. This open-loop configuration may facilitate the use of various water sources as the feed stream, and it allows for the easy discharge of concentrated brine or other waste products, making it well-suited for continuous, large-scale operations. Herein, the feed stream 150 may be any water source that requires desalination, such as seawater, brackish water, or even wastewater. Also, the refrigerant 120 for the ECC system 102 is selected to have appropriate thermodynamic properties, including a suitable boiling point, high latent heat, and low viscosity. One or more refrigerants 120, including, but not limited to, R718, R134a, R290, R12, R600, R245fa, etc. may be used in the ECC system 102 without any limitations. Further, the external cooling source 162 is designed to achieve the low temperature necessary for to condense water vapors therein. This low temperature may be obtained from various sources of cooling load, such as ambient feed intake, and even a portion of the cooling effect from the ECC system 102 and the evaporator 112 thereof.

It may be understood that in the illustrated example of the desalination and cooling system 100 of FIG. 1, the DCMD system 104 is a single-effect distillation system; or in other words, the desalination and cooling system 100 is implemented as a single-effect desalination and cooling system; however, in other examples, the DCMD system 104 may be a multi-effect distillation system, and the corresponding desalination and cooling system 100 may be implemented as a multi-effect desalination and cooling system (as discussed later) without departing from the spirit and the scope of the present disclosure. It may be noted that in a multi-effect configuration, the number of stages depends on a difference between temperatures of the feed stream 150 and the external cooling source 162 at a final stage, which may need to be maintained between 10° C. and 20° C., and at least 10° C. Further, in certain examples, in the DCMD system 104, the feed chamber 152, the permeate chamber 156, the membrane 154, and the external cooling source 162 may be designed as single-effect or multi-effect. Similarly, in the ECC system 102, the heater, or any other heat exchanger (HX), may be single or multiple units, without any limitations.

Also, it may be contemplated by a person skilled in the art that the desalination and cooling system 100 may incorporate various configurations to enhance its efficiency. For instance, in some examples, the permeate chamber 156 may receive the feed stream 150 either as pumped in or in a cooled state thereof. In some examples, the intake feed stream 150 is pre-heated in the condenser 116 and may then further heated in a heater or the like (discussed later) either by a heater entering or exiting the generator 110. Alternatively, the intake feed stream 150 may be further heated in the heater by the super-heated stream of the refrigerant 120 exiting the ejector 114. Also, in certain examples, the condenser 116 of the ECC system 102 and the feed chamber 152 of the DCMD system 104 may be designed to come into direct contact, facilitating heat exchange between the refrigerant 120 and the feed stream 150. In other examples, a portion of the cooling effect produced by the ECC system 102 may be utilized for cooling the feed stream 150 for applications in the DCMD system 104. In still other examples, external chillers (as discussed later) may be used to reduce intake temperature of the feed stream 150 to promote effective vapor condensation in the external cooling source 162 of the DCMD system 104. Further, in certain examples, cycles of the feed stream 150 and the coolant stream 164 may be configured as open, closed, or partially open-closed based on the specific needs of the application. It may be appreciated that for open cycle/loop, the feed stream 150 exiting the DCMD system 104 is rejected, and for a closed cycle(s)/loop(s), the feed stream 150 may be recirculated together with replenished stream.

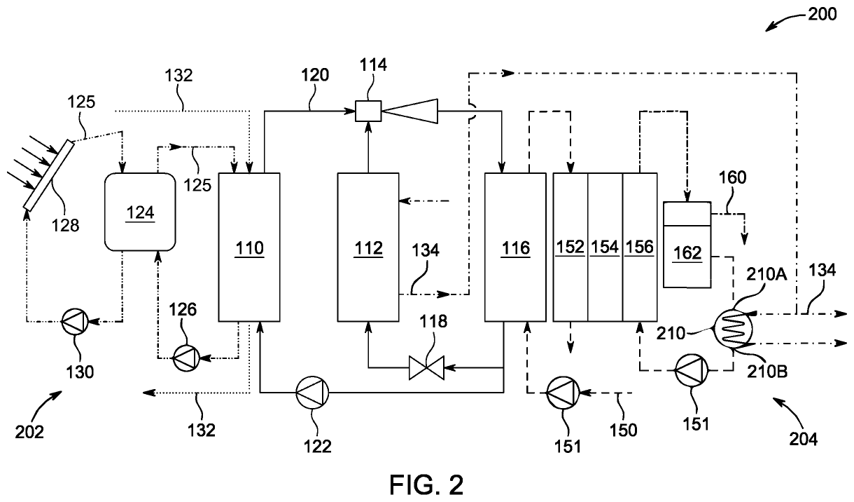

A general overview of the desalination and cooling process as per the present disclosure has been discussed thus far using the desalination and cooling system 100 of FIG. 1 as an exemplary embodiment. The present disclosure provides various alternate configurations to the desalination and cooling system 100. These configurations, which expand upon the basic structure and operation of the desalination and cooling system 100, offer flexibility and adaptability for different operational requirements and environmental conditions. To provide a more comprehensive understanding of these alternate configurations, each has been discussed separately and in detail with reference to FIGS. 2-24. These figures present diverse embodiments of the integrated desalination and cooling process as per the present disclosure, demonstrating versatility and the wide range of applications it can cater to. The detailed descriptions accompanying these figures further elucidate the operation, benefits, and potential implementations of these alternate configurations, thereby offering a more comprehensive understanding of the present disclosure.

Referring to FIG. 2, illustrated is a schematic diagram of a desalination and cooling system 200 having a single-effect configuration, according to certain embodiments. The desalination and cooling system 200 has many similarities with the desalination and cooling system 100 depicted in FIG. 1, such as integrating an ECC system 202 and a DCMD system 204, combining principles of thermodynamic cycles and heat and mass transfer to produce freshwater and provide a cooling effect. The desalination and cooling system 200 has the ECC system 202 and the DCMD system 204 with similar components to the desalination and cooling system 100. These components interact, generally, in a similar manner across both systems, leveraging heat exchange and mass transfer processes to achieve the desired cooling and desalination outcomes. Further, the integration of the ECC system 202 and the DCMD system 204, the circulation of the feed stream 150, and the flow of the refrigerant 120 within the desalination and cooling system 200 are similar to those in the desalination and cooling system 100. Furthermore, the desalination and cooling system 200, similar to the desalination and cooling system 100, maintains fluid connection of the feed stream 150 in an open loop. Further, the condenser 116 of the ECC system 202 is tasked with further heating the feed stream 150. However, as illustrated in FIG. 2, the desalination and cooling system 200 introduces some distinct features in comparison to the desalination and cooling system 100. These features of the desalination and cooling system 200, which are detailed in the subsequent paragraph(s), cater to specific operational requirements or environmental conditions, thereby extending the versatility and applicability of the desalination and cooling system 200.

A feature of the desalination and cooling system 200 lies in the initial processing of the feed stream 150 within the DCMD system 204. As illustrated in FIG. 2, in the desalination and cooling system 200, the feed stream 150 is pre-heated by the waste heat from the condenser 116, before it enters the feed chamber 152 of the desalination and cooling system 200. Further, in the desalination and cooling system 200, the feed stream 150 enters the condenser 116, allowing the feed stream 150 to be heated by the super-heated stream of the refrigerant at the condenser 116, and resulting in the hot feed stream 150, similar to the desalination and cooling system 100. In the desalination and cooling system 200, pre-heating the feed stream 150 reduces the energy required for subsequent heating in the ECC system 202. In other words, by elevating the initial temperature of the feed stream 150, the energy needed to reach the desired operating temperatures within the ECC system 202 is lowered. Thus, pre-heating of the feed stream 150 within the DCMD system 204 improves the overall energy efficiency of the desalination and cooling system 200. Further, another feature of the desalination and cooling system 200, is the inclusion of a heat exchanger 210. The heat exchanger has an inlet 210a connected to the external cooling source 162 and an outlet 210b connected to the permeate chamber 156. In an embodiment, the cooling effect 134 is passed on from the evaporator 112 to the heat exchanger 210 to keep the temperatures low for the heat exchanger 210. The aforementioned process ensures a low temperature maintenance in the external cooling source 162.

In particular, the generator 110, in the ECC system 202, is responsible for generating the primary flow of the refrigerant 120. The evaporator 112, in the ECC system 202, provides cooling and creates the secondary flow of the refrigerant 120. By absorbing heat, the evaporator 112 increases the temperature of the refrigerant 120, causing it to evaporate and create the secondary flow. This secondary flow then joins the primary flow in the ejector 114. The ejector 114 is designed to combine the primary and secondary flows of the refrigerant 120. The ejector 114 takes in the high-pressure primary flow from the generator 110 and the low-pressure secondary flow from the evaporator 112. When these two flows pass through the ejector 114, they mix and produce a super-heated stream of the refrigerant 120. The condenser 116 receives the super-heated stream from the ejector 114 and cools it down. This cooling process results in the condensation of the refrigerant, which releases a significant amount of latent heat.

Further, in the DCMD system 204, the feed chamber 152 is configured to receive a hot stream (which is, generally, same as the feed stream 150, with the two terms being interchangeably used). Further, the permeate chamber 156 is configured to receive a cold stream (which again is, generally, same as the feed stream 150, with the two terms being interchangeably used). The hot stream and the cold stream may be any source of water that requires desalination, such as sea water, brackish water, or even waste water. The membrane 154 is disposed between the feed chamber 152 and the permeate chamber 156. The membrane 154 is designed with a plurality of pores which are configured to selectively allow the passage of water vapor. This selective permeability allows only the water vapor originating from the feed stream 150 to pass from the feed chamber 152 through the membrane 154 to the permeate chamber 156, effectively separating the water from the other contaminants present in the feed stream. The permeate chamber 156 is situated at an end of the DCMD system 204, providing an intermediate space for the permeation of water vapor from the feed chamber 152. The permeate chamber 156, due to its positioning and configuration, allows for the condensation of the water vapor into freshwater 160 through a permeate tank 260. This arrangement allows the desalination and cooling system 200 to achieve an efficient separation of water from the other contaminants in the feed stream 150.

Specifically, in the desalination and cooling system 200, the ECC system 202 and the DCMD system 204 are integrated and connected at the condenser 116 in a manner that allows the feed stream 150 to be heated by the super-heated stream of the refrigerant 120 at the condenser 116. This setup results in the creation of the feed stream 150, which is then directed to the feed chamber 152 of the DCMD system 204.

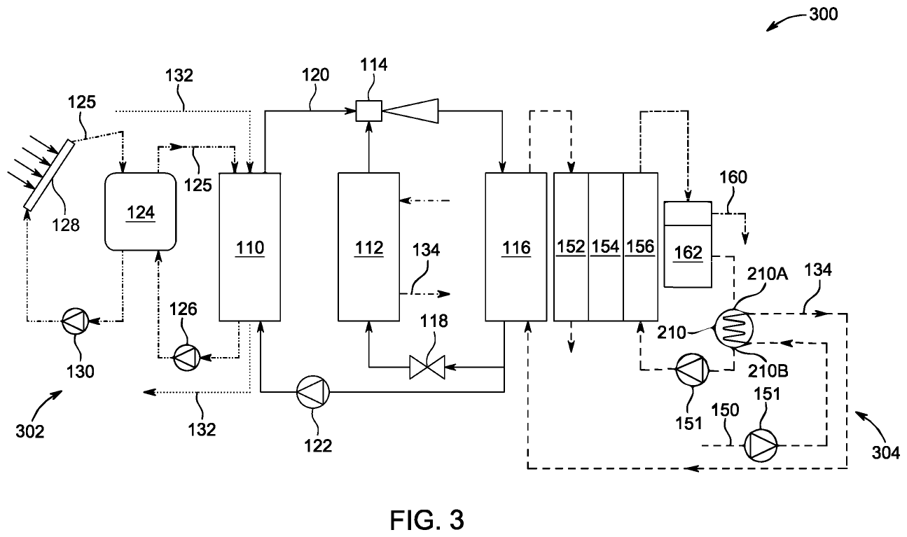

Referring to FIG. 3, illustrated is a schematic diagram of a desalination and cooling system 300 having a single-effect configuration, according to certain embodiments. The desalination and cooling system 300 has many similarities with the desalination and cooling system 200 depicted in FIG. 2, such as integrating an ECC system 302 and a DCMD system 304, combining principles of thermodynamic cycles and heat and mass transfer to produce freshwater and provide a cooling effect. The desalination and cooling system 300 has the ECC system 302 and the DCMD system 304 with similar components to the desalination and cooling system 200. These components interact, generally, in a similar manner across both systems, leveraging heat exchange and mass transfer processes to achieve the desired cooling and desalination outcomes. Further, the integration of the ECC system 302 and the DCMD system 304, the circulation of the feed stream 150, and the flow of the refrigerant 120 within the desalination and cooling system 300 are similar to those in the desalination and cooling system 200. Furthermore, the desalination and cooling system 300, similar to the desalination and cooling system 200, maintains fluid connection of the feed stream 150 in an open loop and employs the condenser 116 of the ECC system 302 for pre-heating the feed stream 150. However, as illustrated in FIG. 3, the desalination and cooling system 300 introduces some distinct features in comparison to the desalination and cooling system 200. These features of the desalination and cooling system 300, which are detailed in the subsequent paragraph(s), cater to specific operational requirements or environmental conditions, thereby extending the versatility and applicability of the desalination and cooling system 300.

A feature of the desalination and cooling system 300 lies in the inclusion of a heat exchanger 210. The heat exchanger 210 receives feed water stream at an inlet 210a via the pump 151. Further, at the outlet 210b of the heat exchanger 210, the heat exchanger 210 provides the primary feed stream to the condenser 116. Further, as illustrated, the heat exchanger 210 of the desalination and cooling system 300 allows for efficient heat transfer between the feed stream 150, and the refrigerant 120 (or said other fluid) from the evaporator 112 of the ECC system 302. Within the heat exchanger 210, these two streams come into close proximity but do not mix, creating an efficient setup for heat transfer. This cooling step of the feed stream 150 may enhance the efficiency of the vapor generation process within the DCMD system 304. By reducing the temperature of the feed stream 150 before it enters the permeate chamber 156, the temperature gradient across the membrane 154 (i.e., with respect the feed chamber 152) is maximized. This larger temperature difference may stimulate a more efficient vapor generation process, leading to increased desalination productivity.

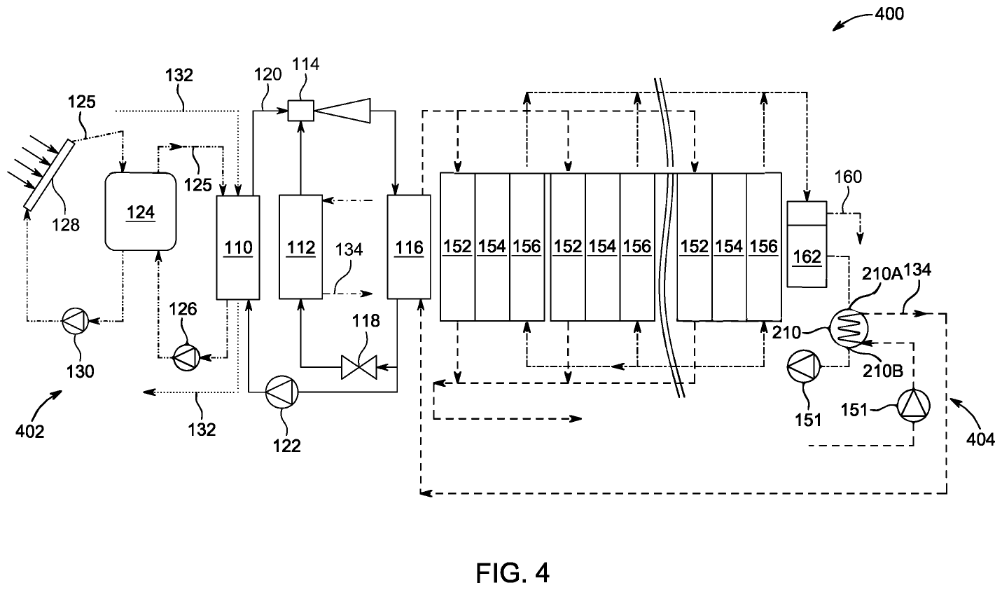

Referring to FIG. 4, illustrated is a schematic diagram of a desalination and cooling system 400 having a multi-effect configuration, according to certain embodiments. The desalination and cooling system 400 has many similarities with the desalination and cooling system 300 depicted in FIG. 3, such as integrating an ECC system 402 and a DCMD system 404, combining principles of thermodynamic cycles and heat and mass transfer to produce freshwater and provide a cooling effect. The desalination and cooling system 400 has the ECC system 402 and the DCMD system 404 with similar components to the desalination and cooling system 300. These components interact, generally, in a similar manner across both systems, leveraging heat exchange and mass transfer processes to achieve the desired cooling and desalination outcomes. Further, the integration of the ECC system 402 and the DCMD system 404, the circulation of the feed stream 150, and the flow of the refrigerant 120 within the desalination and cooling system 400 are similar to those in the desalination and cooling system 300. Furthermore, the desalination and cooling system 400, similar to the desalination and cooling system 200, maintains fluid connection of the feed stream 150 in an open loop and employs the permeate chamber 156 of the DCMD system 404 for pre-heating the feed stream 150. Also, the condenser 116 of the ECC system 402 is tasked with further heating the feed stream 150. However, as illustrated in FIG. 4, the desalination and cooling system 400 introduces some distinct features in comparison to the desalination and cooling system 200. These features of the desalination and cooling system 400, which are detailed in the subsequent paragraph(s), cater to specific operational requirements or environmental conditions, thereby extending the versatility and applicability of the desalination and cooling system 400.

A feature of the desalination and cooling system 400 lies in incorporation of a multi effect configuration of the DCMD system 404. The desalination and cooling system 400 includes multiple DCMD modules, i.e., a plurality of feed chambers 152, a plurality of membranes 154 and a plurality of permeate chambers 156. This feature sets the desalination and cooling system 400 apart from the previously discussed desalination and cooling system 300. That is, unlike the desalination and cooling system 300, which utilizes a single component structure (i.e., a single feed chamber, a single membrane and a single permeate chamber), the DCMD system 404 of the desalination and cooling system 400 includes a plurality of the aforementioned components. Subsequently, the desalination capacity of the DCMD system 404 is increased as compared to the desalination and cooling system 300. The multiple stages allows for opportunity of incremental heat generation, vaporization, and condensation, thereby increasing the overall efficiency and output of the DCMD system 404.

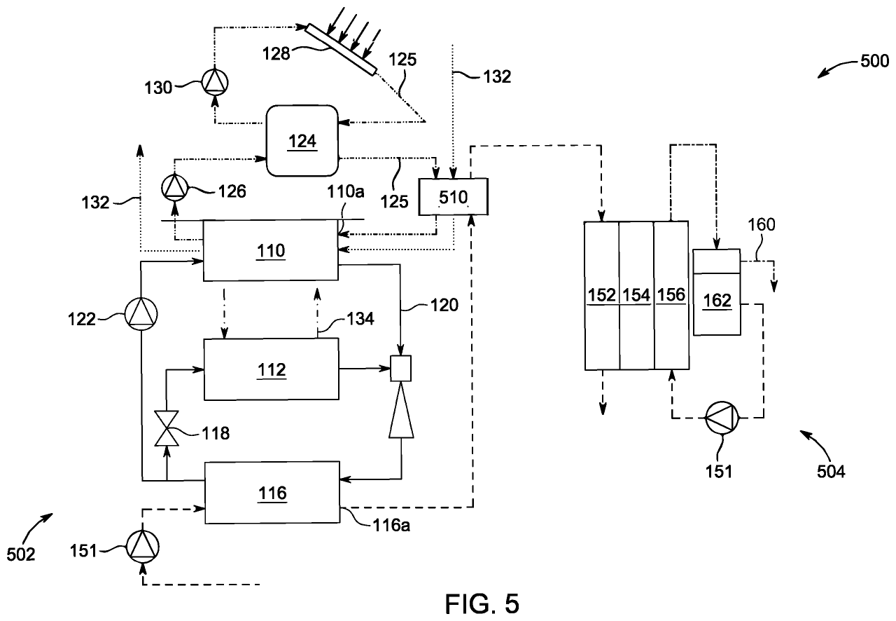

Referring to FIG. 5, illustrated is a schematic diagram of a desalination and cooling system 500 having a single-effect configuration, according to certain embodiments. The desalination and cooling system 500 has many similarities with the desalination and cooling system 200 depicted in FIG. 2, such as integrating an ECC system 502 and a DCMD system 504, combining principles of thermodynamic cycles and heat and mass transfer to produce freshwater and provide a cooling effect. The desalination and cooling system 500 has the ECC system 502 and the DCMD system 504 with similar components to the desalination and cooling system 200. These components interact, generally, in a similar manner across both systems, leveraging heat exchange and mass transfer processes to achieve the desired cooling and desalination outcomes. Further, the integration of the ECC system 502 and the DCMD system 504, the circulation of the feed stream 150, and the flow of the refrigerant 120 within the desalination and cooling system 500 are similar to those in the desalination and cooling system 200. Furthermore, the desalination and cooling system 500, similar to the desalination and cooling system 200, maintains fluid connection of the feed stream 150 in an open loop. Also, the condenser 116 of the ECC system 502 is tasked with further heating the feed stream 150. However, as illustrated in FIG. 5, the desalination and cooling system 500 introduces some distinct features in comparison to the desalination and cooling system 200. These features of the desalination and cooling system 500, which are detailed in the subsequent paragraph(s), cater to specific operational requirements or environmental conditions, thereby extending the versatility and applicability of the desalination and cooling system 500.

A feature of the desalination and cooling system 500, as illustrated in FIG. 5, lies in its integration of a heat source, positioned at an inlet 110a to the generator 110 and an outlet 116a to the condenser 116 of the ECC system 502, for directly heating the feed stream 150. In particular, the ECC system 502 includes a heater 510 that is configured to provide heat for the generator 110 to generate the primary flow of the refrigerant 120. As illustrated, the heater 510 may be powered by various heat sources, such as the waste heat 132. The heater 510 transfers this thermal energy to the refrigerant 120 within the generator 110, elevating temperature of the refrigerant 120. Further, the heater 510 is configured to further heat the feed stream 150 after the condenser 116 and before the feed chamber 152. That is, the heater 510 heats the feed stream 150 directly, providing an additional temperature boost before the feed stream 150 enters the feed chamber 152 of the DCMD system 504. By introducing this direct heating stage, the desalination and cooling system 500 may reach higher temperatures for the feed stream 150, which may lead to more efficient vapor generation and consequently, improved desalination productivity. In some embodiments, the heater 510 and the feed chamber 152 may be in direct contact with each other, allowing for immediate and efficient heat transfer from the heater 510 to the feed stream 150. This setup minimizes heat loss, further improving the energy efficiency of the desalination and cooling system 500. The use of the heater 510 provides the desalination and cooling system 500 with additional flexibility. The heater 510 may be easily controlled to adjust temperature of the feed stream 150 based on specific desalination requirements, ambient conditions, or energy availability. This means that the desalination and cooling system 500 may be adapted to a wide range of scenarios and operational conditions.

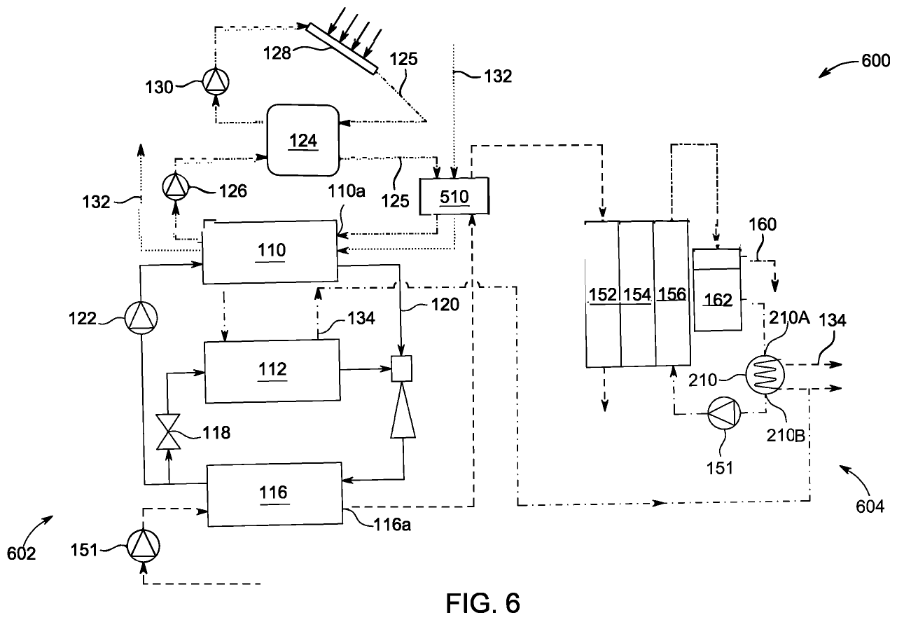

Referring to FIG. 6, illustrated is a schematic diagram of a desalination and cooling system 600 having a single-effect configuration, according to certain embodiments. The desalination and cooling system 600 has many similarities with the desalination and cooling system 500 depicted in FIG. 5, such as integrating an ECC system 602 and a DCMD system 604, combining principles of thermodynamic cycles and heat and mass transfer to produce freshwater and provide a cooling effect. The desalination and cooling system 600 has the ECC system 602 and the DCMD system 604 with similar components to the desalination and cooling system 500. These components interact, generally, in a similar manner across both systems, leveraging heat exchange and mass transfer processes to achieve the desired cooling and desalination outcomes. Further, the integration of the ECC system 602 and the DCMD system 604, the circulation of the feed stream 150, and the flow of the refrigerant 120 within the desalination and cooling system 600 are similar to those in the desalination and cooling system 500. Furthermore, the desalination and cooling system 600, similar to the desalination and cooling system 500, maintains fluid connection of the feed stream 150 in an open loop. Also, the condenser 116 of the ECC system 602 is tasked with further heating the feed stream 150. However, as illustrated in FIG. 6, the desalination and cooling system 600 introduces some distinct features in comparison to the desalination and cooling system 500. These features of the desalination and cooling system 600, which are detailed in the subsequent paragraph(s), cater to specific operational requirements or environmental conditions, thereby extending the versatility and applicability of the desalination and cooling system 600.

A feature of the desalination and cooling system 600, as illustrated in FIG. 6, is its dual functionality of both heating the feed stream 150 and cooling the external cooling source 162, achieved through the integration of the heater 510 at the inlet 110a to the generator 110 of the ECC system 602 and the utilization of the cooling effect provided by the evaporator 112 of the ECC system 602. Similar to the desalination and cooling system 500, the desalination and cooling system 500 incorporates the additional heating stage through the inclusion of the heater 510. The heater 510 directly heats the feed stream 150, elevating its temperature before it enters the feed chamber 152 of the DCMD system 604. The direct heating from the heater 510 may lead to more efficient vapor generation, resulting in improved desalination productivity. Additionally, the desalination and cooling system 600 also takes advantage of the cooling effect 134 produced by the evaporator 112 of the ECC system 602. A portion of the cooling effect 134 is utilized to cool the external cooling source, via the heat exchanger 210, which helps manage the thermal load and enhances the overall energy efficiency of the desalination and cooling system 600. The dual functionality of the desalination and cooling system 600, providing additional heating to the feed stream 150 entering the feed chamber 152 while also cooling the external cooling source 162, gives it a distinctive operational advantage. The desalination and cooling system 600 not only improves the conditions for vapor generation in the DCMD system 604, but also effectively manages the thermal conditions of the feed stream 150.

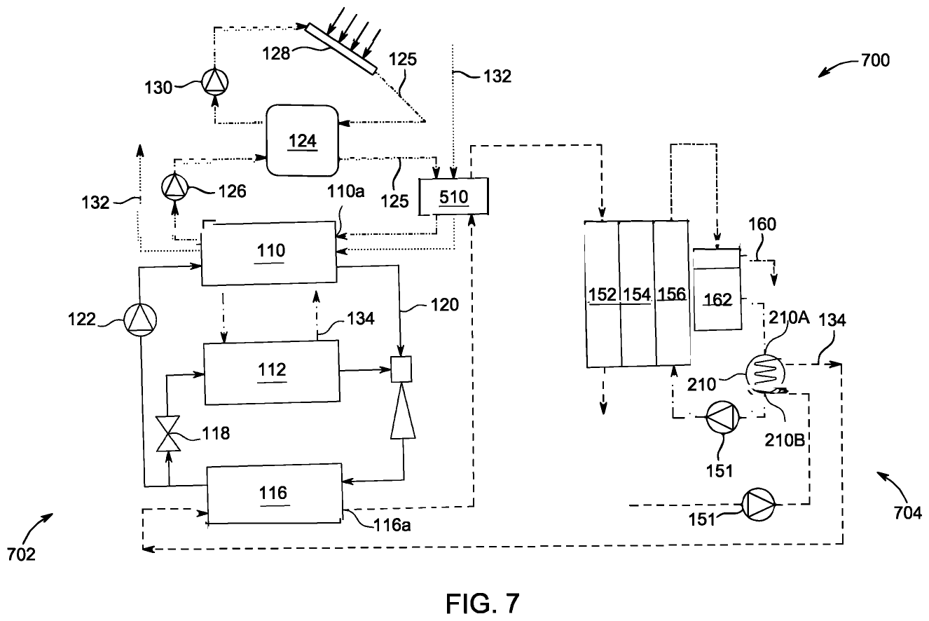

Referring to FIG. 7, illustrated is a schematic diagram of a desalination and cooling system 700 having a single-effect configuration, according to certain embodiments. The desalination and cooling system 700 has many similarities with the desalination and cooling system 300 depicted in FIG. 3, such as integrating an ECC system 702 and a DCMD system 704, combining principles of thermodynamic cycles and heat and mass transfer to produce freshwater and provide a cooling effect. The desalination and cooling system 700 has the ECC system 702 and the DCMD system 704 with similar components to the desalination and cooling system 300. These components interact, generally, in a similar manner across both systems, leveraging heat exchange and mass transfer processes to achieve the desired cooling and desalination outcomes. Further, the integration of the ECC system 702 and the DCMD system 704, the circulation of the feed stream 150, and the flow of the refrigerant 120 within the desalination and cooling system 700 are similar to those in the desalination and cooling system 300. Furthermore, the desalination and cooling system 700, similar to the desalination and cooling system 600, maintains fluid connection of the feed stream 150 in an open loop. Also, the condenser 116 of the ECC system 702 is tasked with further heating the feed stream 150. However, as illustrated in FIG. 7, the desalination and cooling system 700 introduces some distinct features in comparison to the desalination and cooling system 300. These features of the desalination and cooling system 700, which are detailed in the subsequent paragraph(s), cater to specific operational requirements or environmental conditions, thereby extending the versatility and applicability of the desalination and cooling system 700.

A feature of the desalination and cooling system 700, as illustrated in FIG. 7, is its dual functionality of both heating the feed stream 150 and utilizing the waste heat from the condenser 116 for heating the feed water coming from heat exchanger 210, achieved through the integration of the heater 510 at the inlet 110a to the generator 110 of the ECC system 702 and the utilization of the heating effect provided by the condenser 116 of the ECC system 702. Similar to the desalination and cooling system 300, the desalination and cooling system 700 incorporates the additional heating stage through the inclusion of the heater 510. The heater 510 directly heats the feed stream 150, elevating its temperature before it enters the feed chamber 152 of the DCMD system 704. The direct heating from the heater 510 may lead to more efficient vapor generation, resulting in improved desalination productivity. Additionally, the desalination and cooling system 700 also takes advantage of the heating effect produced by the evaporator 112 of the ECC system 702. A portion of the heating effect is utilized to pre-heat the feed water coming from the heat exchanger 210, which helps manage the thermal load and enhances the overall energy efficiency of the desalination and cooling system 700. The dual functionality of the desalination and cooling system 700, gives it a distinctive operational advantage. The desalination and cooling system 700 not only improves the conditions for vapor generation in the DCMD system 704, but also effectively manages the thermal conditions of the feed stream 150, which may lead to a more efficient and productive desalination process.

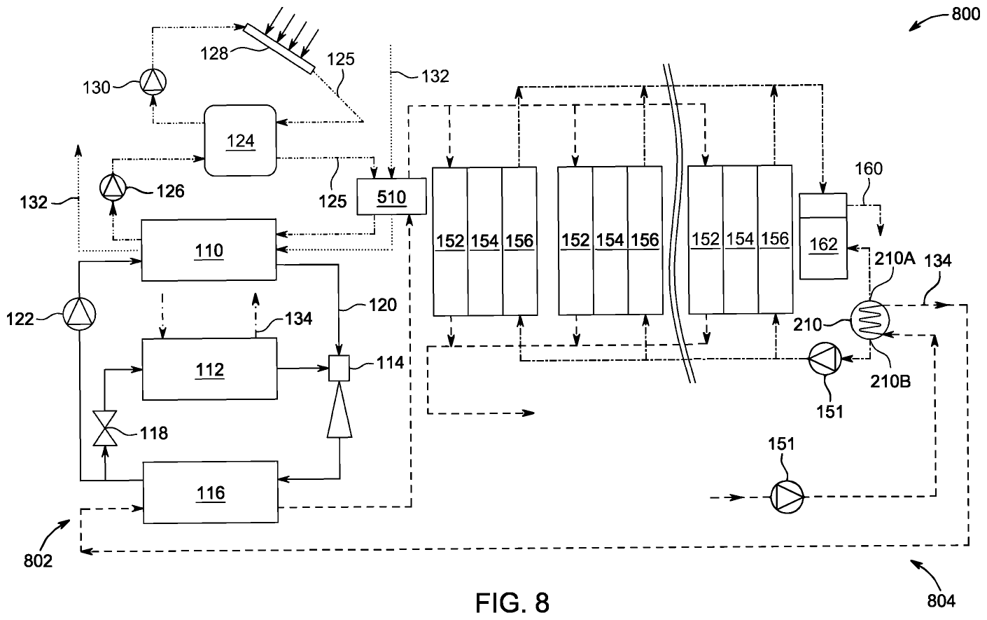

Referring to FIG. 8, illustrated is a schematic diagram of a desalination and cooling system 800 having a multi-effect configuration, according to certain embodiments. The desalination and cooling system 800 has many similarities with the desalination and cooling system illustrated in FIG. 7. Such as, integrating an ECC system 802 and a DCMD system 804, combining principles of thermodynamic cycles and heat and mass transfer to produce freshwater and provide a cooling effect. The desalination and cooling system 800 has the ECC system 802 and the DCMD system 804 with similar components to the desalination and cooling system 700. These components interact, generally, in a similar manner across both systems, leveraging heat exchange and mass transfer processes to achieve the desired cooling and desalination outcomes. Further, the integration of the ECC system 802 and the DCMD system 804, the circulation of the feed stream 150, and the flow of the refrigerant 120 within the desalination and cooling system 800 are similar to those in the desalination and cooling system 700. Furthermore, the desalination and cooling system 800, similar to the desalination and cooling system 600, maintains fluid connection of the feed stream 150 in an open loop. Also, the condenser 116 of the ECC system 802 is tasked with further heating the feed stream 150. However, as illustrated in FIG. 8, the desalination and cooling system 800 introduces some distinct features in comparison to the desalination and cooling system 600. These features of the desalination and cooling system 800, which are detailed in the subsequent paragraph(s), cater to specific operational requirements or environmental conditions, thereby extending the versatility and applicability of the desalination and cooling system 800.

A feature of the desalination and cooling system 800, as illustrated in FIG. 8, is its multi-effect configuration. Specifically, in the desalination and cooling system 800, the DCMD system 804 has multi-effect configuration providing multiple DCMD units arranged in a staged manner, and each one including respective feed chamber 152, respective permeate chamber 156, and respective membrane 154. These multiple stages offer the opportunity for progressive and incremental heating, vapor generation, and condensation, thereby enhancing the overall efficiency and productivity of the desalination process. It may be understood that the desalination and cooling system 800 utilizes a single ECC system 802. Herein, the DCMD system 804 may have the multiple DCMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the DCMD system 804. The multi-effect configuration provides the desalination and cooling system 800 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple permeate chambers 156 allows for precise control over the temperature and flow rates at each stage, enhancing both the desalination and cooling efficiencies of the desalination and cooling system 800.

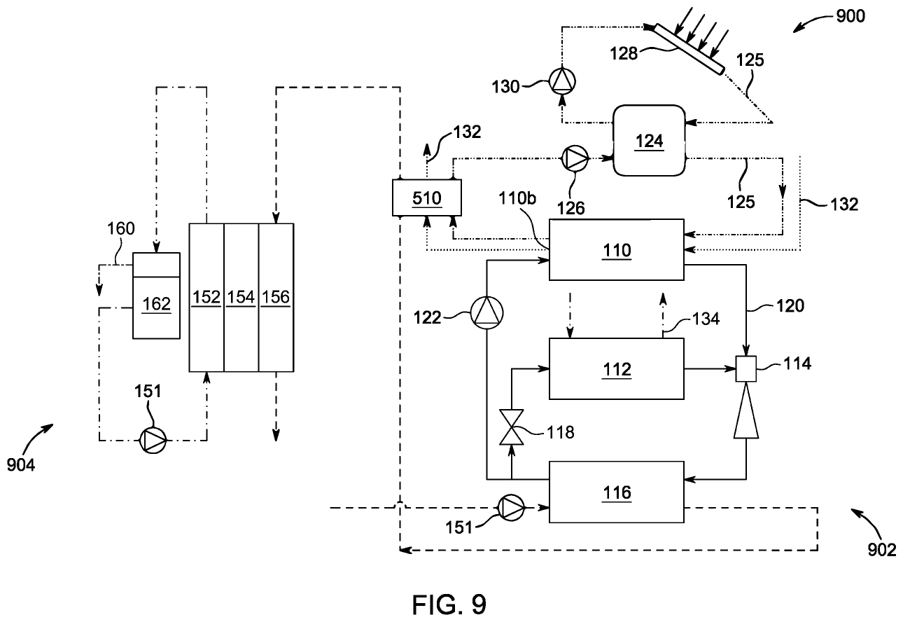

Referring to FIG. 9, illustrated is a schematic diagram of a desalination and cooling system 900 having a single-effect configuration, according to certain embodiments. The desalination and cooling system 900 has many similarities with the desalination and cooling system 500 depicted in FIG. 5, such as integrating an ECC system 902 and a DCMD system 904, combining principles of thermodynamic cycles and heat and mass transfer to produce freshwater and provide a cooling effect. The desalination and cooling system 900 has the ECC system 902 and the DCMD system 904 with similar components to the desalination and cooling system 500. These components interact, generally, in a similar manner across both systems, leveraging heat exchange and mass transfer processes to achieve the desired cooling and desalination outcomes. Further, the integration of the ECC system 902 and the DCMD system 904, the circulation of the feed stream 150, and the flow of the refrigerant 120 within the desalination and cooling system 900 are similar to those in the desalination and cooling system 600. Furthermore, the desalination and cooling system 900, similar to the desalination and cooling system 600, maintains fluid connection of the feed stream 150 in an open. Also, the condenser 116 of the ECC system 902 is tasked with further heating the feed stream 150. However, as illustrated in FIG. 9, the desalination and cooling system 900 introduces some distinct features in comparison to the desalination and cooling system 500. These features of the desalination and cooling system 900, which are detailed in the subsequent paragraph(s), cater to specific operational requirements or environmental conditions, thereby extending the versatility and applicability of the desalination and cooling system 900.

A feature of the desalination and cooling system 900, as illustrated in FIG. 9, is its integration of the heater 510 at an outlet 110b of the generator 110 of the ECC system 902, providing additional heating to the feed stream 150. The desalination and cooling system 900 is distinguished by its placement of the heater 510 at the outlet 110b of the generator 110, as compared to at the inlet 110a of the generator 110 in the desalination and cooling system 500 In the present configuration, the heater 510 may use the heated refrigerant 120 from the generator 110 (which may use the waste heat 132 directly) for providing the heat, and further exhaust the remaining waste heat 132 out. Herein, the heater 510 provides additional heating to the feed stream 150 after it has been processed by the condenser 116 in the ECC system 902, further elevating its temperature before it enters the feed chamber 152 of the DCMD system 904. This additional heating may lead to more efficient vapor generation, which in turn may enhance desalination productivity. The integration of the heater 510 at the outlet 110b of the generator 110 provides the desalination and cooling system 900 with a operational advantage. The heater 510 enables the desalination and cooling system 900 to control the temperature of the feed stream 150 more precisely, allowing for improvement of the conditions for vapor generation in the DCMD system 904. This capability may lead to a more efficient and productive desalination process, and may further lead to improvements in the overall energy efficiency of the desalination and cooling system 900, making it more economical to operate.

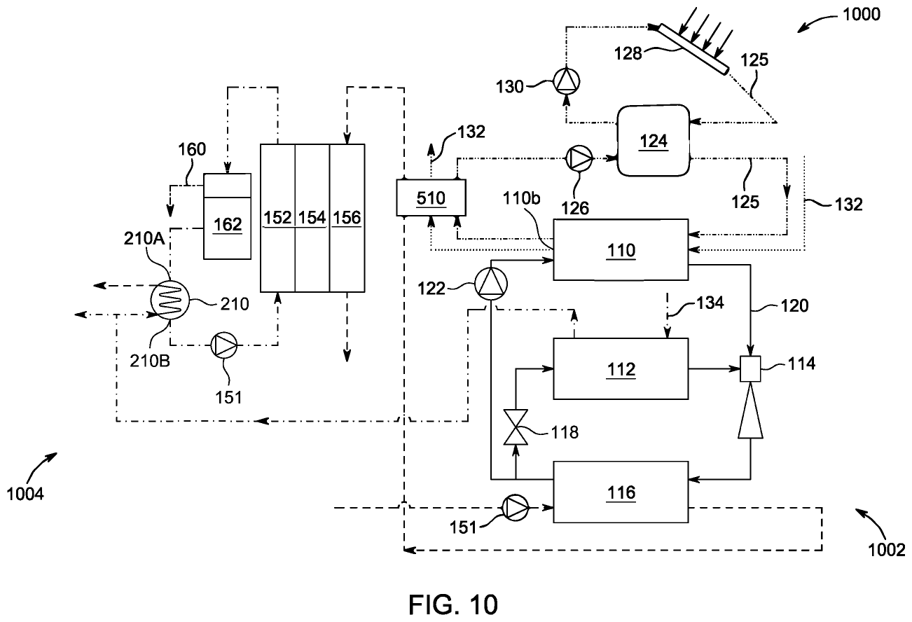

Referring to FIG. 10, illustrated is a schematic diagram of a desalination and cooling system 1000 having a single-effect configuration, according to certain embodiments. The desalination and cooling system 1000 has many similarities with the desalination and cooling system 600 depicted in FIG. 6, such as integrating an ECC system 1002 and a DCMD system 1004, combining principles of thermodynamic cycles and heat and mass transfer to produce freshwater and provide a cooling effect. The desalination and cooling system 1000 has the ECC system 1002 and the DCMD system 1004 with similar components to the desalination and cooling system 600. These components interact, generally, in a similar manner across both systems, leveraging heat exchange and mass transfer processes to achieve the desired cooling and desalination outcomes. Further, the integration of the ECC system 1002 and the DCMD system 1004, the circulation of the feed stream 150, and the flow of the refrigerant 120 within the desalination and cooling system 1000 are similar to those in the desalination and cooling system 900. Furthermore, the desalination and cooling system 1000, similar to the desalination and cooling system 600, maintains fluid connection of the feed stream 150 in an open. Also, the condenser 116 of the ECC system 1002 is tasked with further heating the feed stream 150. However, as illustrated in FIG. 10, the desalination and cooling system 1000 introduces some distinct features in comparison to the desalination and cooling system 600. These features of the desalination and cooling system 1000, which are detailed in the subsequent paragraph(s), cater to specific operational requirements or environmental conditions, thereby extending the versatility and applicability of the desalination and cooling system 1000.

A feature of the desalination and cooling system 1000, as illustrated in FIG. 10, is its dual functionality of both heating the feed stream 150 and utilization of the cooling effect 134 of the evaporator 112 by the heat exchanger 210, achieved through the integration of the heater 510 at the outlet 110b to the generator 110 of the ECC system 1002 and the utilization of the cooling effect provided by the evaporator 112 of the ECC system 1002. Similar to the desalination and cooling system 600, the desalination and cooling system 1000 incorporates the additional heating stage through the inclusion of the heater 510. The heater 510 directly heats the feed stream 150, elevating its temperature before it enters the feed chamber 152 of the DCMD system 1004. The direct heating from the heater 510 may lead to more efficient vapor generation, resulting in improved desalination productivity. Additionally, the desalination and cooling system 1000 also takes advantage of the cooling effect 134 produced by the evaporator 112 of the ECC system 1002. A portion of the cooling effect 134 is utilized to cool the heat exchanger 210 (similar to the desalination and cooling system 600), which helps manage the thermal load and enhances the overall energy efficiency of the desalination and cooling system 1000. The dual functionality of the desalination and cooling system 1000, providing additional heating to the feed stream 150 entering the feed chamber 152 while also cooling the heat exchanger 210 gives it a distinctive operational advantage. The desalination and cooling system 1000 not only improves the conditions for vapor generation in the DCMD system 1004, but also effectively manages the thermal conditions of the feed stream 150, which may lead to a more efficient and productive desalination process.

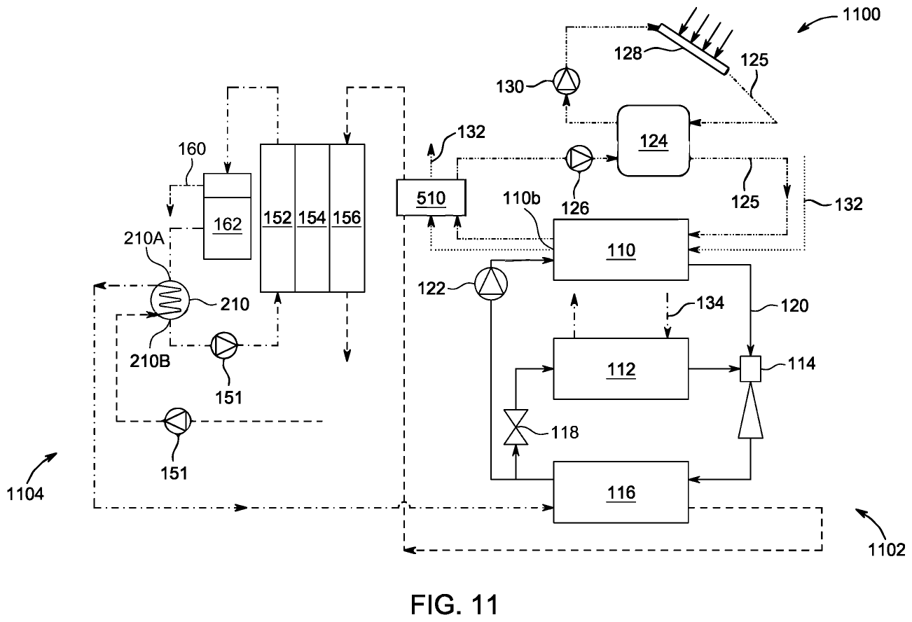

Referring to FIG. 11, illustrated is a schematic diagram of a desalination and cooling system 1100 having a single-effect configuration, according to certain embodiments. The desalination and cooling system 1100 has many similarities with the desalination and cooling system 700 depicted in FIG. 7, such as integrating an ECC system 1102 and a DCMD system 1104, combining principles of thermodynamic cycles and heat and mass transfer to produce freshwater and provide a cooling effect. The desalination and cooling system 1100 has the ECC system 1102 and the DCMD system 1104 with similar components to the desalination and cooling system 1000. These components interact, generally, in a similar manner across both systems, leveraging heat exchange and mass transfer processes to achieve the desired cooling and desalination outcomes. Further, the integration of the ECC system 1102 and the DCMD system 1104, the circulation of the feed stream 150, and the flow of the refrigerant 120 within the desalination and cooling system 1100 are similar to those in the desalination and cooling system 700. Furthermore, the desalination and cooling system 1100, similar to the desalination and cooling system 700, maintains fluid connection of the feed stream 150 in an open loop. Also, the condenser 116 of the ECC system 1102 is tasked with further heating the feed stream 150. However, as illustrated in FIG. 11, the desalination and cooling system 1100 introduces some distinct features in comparison to the desalination and cooling system 700. These features of the desalination and cooling system 1100, which are detailed in the subsequent paragraph(s), cater to specific operational requirements or environmental conditions, thereby extending the versatility and applicability of the desalination and cooling system 1100.

A feature of the desalination and cooling system 1100, as illustrated in FIG. 11, is its dual functionality of both heating and cooling the feed stream 150, where the external cooling source 162 is employed to cool the feed stream 150. This feature sets the desalination and cooling system 1100 apart from the previously discussed desalination and cooling system 700.

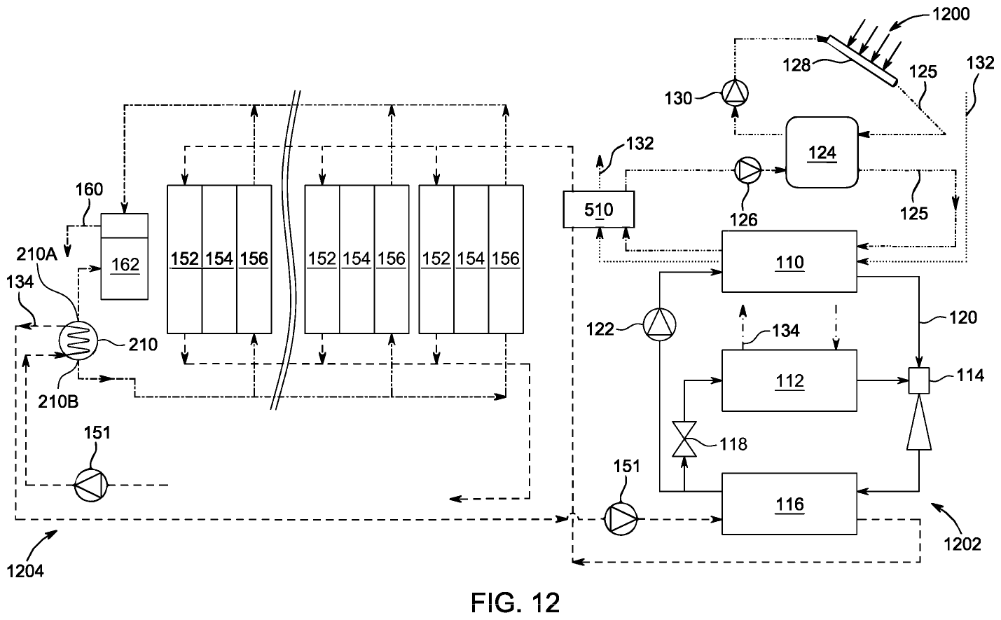

Referring to FIG. 12, illustrated is a schematic diagram of a desalination and cooling system 1200 having a multi-effect configuration, according to certain embodiments. The desalination and cooling system 1200 has many similarities with the desalination and cooling system 800 depicted in FIG. 8, such as integrating an ECC system 1202 and a DCMD system 1204, combining principles of thermodynamic cycles and heat and mass transfer to produce freshwater and provide a cooling effect. The desalination and cooling system 1200 has the ECC system 1202 and the DCMD system 1204 with similar components to the desalination and cooling system 800. These components interact, generally, in a similar manner across both systems, leveraging heat exchange and mass transfer processes to achieve the desired cooling and desalination outcomes. Further, the integration of the ECC system 1202 and the DCMD system 1204, the circulation of the feed stream 150, and the flow of the refrigerant 120 within the desalination and cooling system 1200 are similar to those in the desalination and cooling system 800. Furthermore, the desalination and cooling system 1200, similar to the desalination and cooling system 800, maintains fluid connection of the feed stream 150 in an open. Also, the condenser 116 of the ECC system 1202 is tasked with further heating the feed stream 150. However, as illustrated in FIG. 12, the desalination and cooling system 1200 introduces some distinct features in comparison to the desalination and cooling system 800. These features of the desalination and cooling system 1200, which are detailed in the subsequent paragraph(s), cater to specific operational requirements or environmental conditions, thereby extending the versatility and applicability of the desalination and cooling system 1200.

A feature of the desalination and cooling system 1200, as illustrated in FIG. 12, is its multi-effect configuration. Specifically, in the desalination and cooling system 1200, the DCMD system 1204 has multi-effect configuration providing multiple DCMD units arranged in a staged manner, and each one including respective feed chamber 152, respective permeate chamber 156, and respective membrane 154. These multiple stages offer the opportunity for progressive and incremental heating, vapor generation, and condensation, thereby enhancing the overall efficiency and productivity of the desalination process. It may be understood that the desalination and cooling system 1200 utilizes a single ECC system 1202. Herein, the DCMD system 1204 may have the multiple DCMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the DCMD system 1204. The multi-effect configuration provides the desalination and cooling system 1200 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple permeate chambers 156 allows for precise control over the temperature and flow rates at each stage, enhancing both the desalination and cooling efficiencies of the desalination and cooling system 1200.

Referring to FIG. 13, illustrated is a schematic diagram of a desalination and cooling system 1300 having a single-effect configuration, according to certain embodiments. The desalination and cooling system 1300 has many similarities with the desalination and cooling system 900 depicted in FIG. 9, such as integrating an ECC system 1302 and a DCMD system 1304, combining principles of thermodynamic cycles and heat and mass transfer to produce freshwater and provide a cooling effect. The desalination and cooling system 1300 has the ECC system 1302 and the DCMD system 1304 with similar components to the desalination and cooling system 900. These components interact, generally, in a similar manner across both systems, leveraging heat exchange and mass transfer processes to achieve the desired cooling and desalination outcomes. Further, the integration of the ECC system 1302 and the DCMD system 1304, the circulation of the feed stream 150, and the flow of the refrigerant 120 within the desalination and cooling system 1300 are similar to those in the desalination and cooling system 900. Furthermore, the desalination and cooling system 1300, similar to the desalination and cooling system 900, maintains fluid connection of the feed stream 150 in an open loop. Also, the condenser 116 of the ECC system 1302 is tasked with further heating the feed stream 150. However, as illustrated in FIG. 13, the desalination and cooling system 1300 introduces some distinct features in comparison to the desalination and cooling system 900. These features of the desalination and cooling system 1300, which are detailed in the subsequent paragraph(s), cater to specific operational requirements or environmental conditions, thereby extending the versatility and applicability of the desalination and cooling system 1300.

A feature of the desalination and cooling system 1300, as illustrated in FIG. 13, is its integration of the heater 510 at an outlet 114a of the ejector 114 of the ECC system 1302, providing additional heating to the feed stream 150. In the present configuration, the heater 510 may use the super-heated refrigerant 120 exiting the ejector 114 for providing the heat. Herein, the heater 510 provides additional heating to the feed stream 150 after it has been processed by the condenser 116 in the ECC system 1302, further elevating its temperature before it enters the feed chamber 152 of the DCMD system 1304. This additional heating may lead to more efficient vapor generation, which in turn may enhance desalination productivity. In an alternate configuration, the heater 510 may be configured to further heat the super-heated stream of the refrigerant 120 before the super-heated stream of the refrigerant 120 enters the condenser 116. The integration of the heater 510 at the outlet 114a of the ejector 114 provides the desalination and cooling system 1300 with a operational advantage. The heater 510 enables the desalination and cooling system 1300 to significantly elevate the temperature of the feed stream 150, allowing for increased vapor generation in the DCMD system 1304. This capability may lead to a more efficient and productive desalination process, and may further lead to improvements in the overall energy efficiency of the desalination and cooling system 1300, making it more economical to operate.

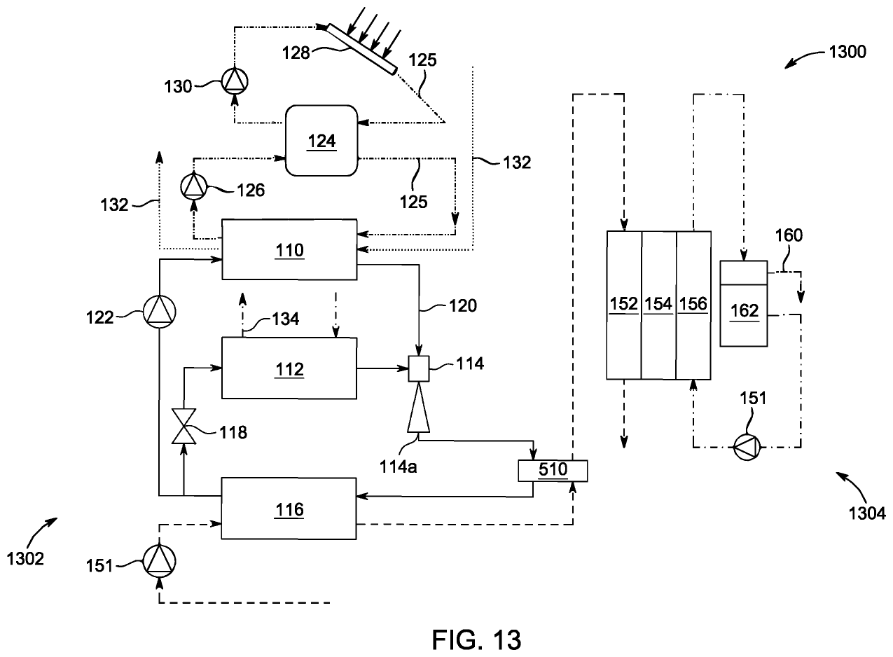

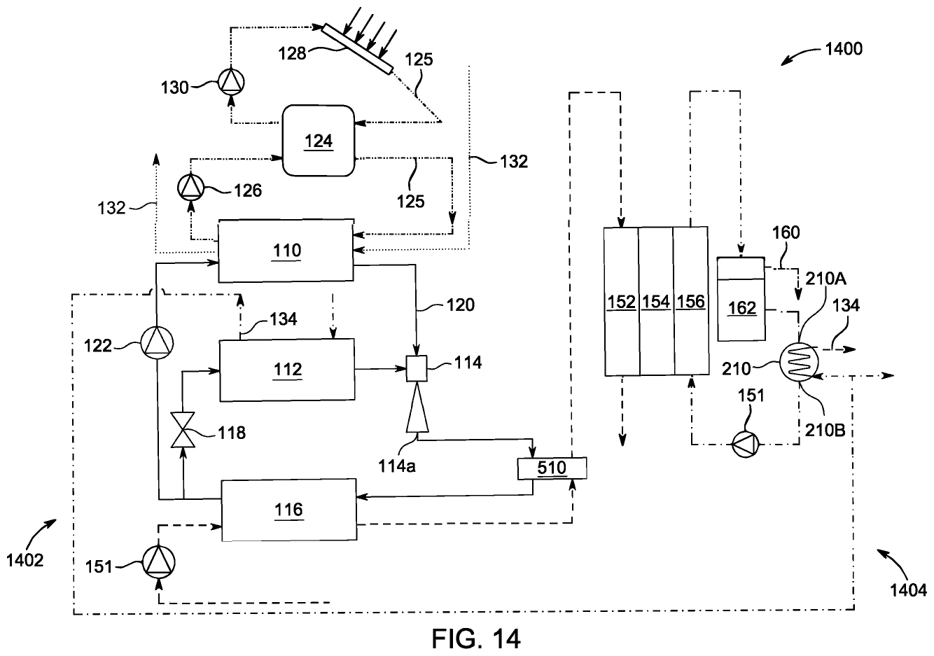

Referring to FIG. 14, illustrated is a schematic diagram of a desalination and cooling system 1400 having a single-effect configuration, according to certain embodiments. The desalination and cooling system 1400 has many similarities with the desalination and cooling system 1300 depicted in FIG. 13, such as integrating an ECC system 1402 and a DCMD system 1404, combining principles of thermodynamic cycles and heat and mass transfer to produce freshwater and provide a cooling effect. The desalination and cooling system 1400 has the ECC system 1402 and the DCMD system 1404 with similar components to the desalination and cooling system 1300. These components interact, generally, in a similar manner across both systems, leveraging heat exchange and mass transfer processes to achieve the desired cooling and desalination outcomes. Further, the integration of the ECC system 1402 and the DCMD system 1404, the circulation of the feed stream 150, and the flow of the refrigerant 120 within the desalination and cooling system 1400 are similar to those in the desalination and cooling system 1300. Furthermore, the desalination and cooling system 1400, similar to the desalination and cooling system 1300, maintains fluid connection of the feed stream 150 in an open loop 150. Also, the condenser 116 of the ECC system 1402 is tasked with further heating the feed stream 150. However, as illustrated in FIG. 14, the desalination and cooling system 1400 introduces some distinct features in comparison to the desalination and cooling system 1300. These features of the desalination and cooling system 1400, which are detailed in the subsequent paragraph(s), cater to specific operational requirements or environmental conditions, thereby extending the versatility and applicability of the desalination and cooling system 1400.

A feature of the desalination and cooling system 1400, as illustrated in FIG. 14, is its dual functionality of both heating the feed stream 150 and the utilization of the cooling effect 134 of the evaporator 112, by the heat exchanger 210, achieved through the integration of the heater 510 at the outlet 114a to the ejector 114 of the ECC system 1402 and the utilization of the cooling effect 134 provided by the evaporator 112 of the ECC system 1402. Similar to the desalination and cooling system 1300, the desalination and cooling system 1400 incorporates the additional heating stage through the inclusion of the heater 510. The heater 510 directly heats the feed stream 150, elevating its temperature before it enters the feed chamber 152 of the DCMD system 1404. The direct heating from the heater 510 may lead to more efficient vapor generation, resulting in improved desalination productivity. Additionally, the desalination and cooling system 1400 also takes advantage of the cooling effect 134 produced by the evaporator 112 of the ECC system 1402. The dual functionality of the desalination and cooling system 1400, providing additional heating to the feed stream 150 entering the feed chamber 152 while also cooling the heat exchanger 210, gives it a distinctive operational advantage. The desalination and cooling system 1400 not only improves the conditions for vapor generation in the DCMD system 1404, but also effectively manages the thermal conditions of the feed stream 150, which may lead to a more efficient and productive desalination process.

Referring to FIG. 15, illustrated is a schematic diagram of a desalination and cooling system 1500 having a single-effect configuration, according to certain embodiments. The desalination and cooling system 1500 has many similarities with the desalination and cooling system 1400 depicted in FIG. 14, such as integrating an ECC system 1502 and a DCMD system 1504, combining principles of thermodynamic cycles and heat and mass transfer to produce freshwater and provide a cooling effect. The desalination and cooling system 1500 has the ECC system 1502 and the DCMD system 1504 with similar components to the desalination and cooling system 1400. These components interact, generally, in a similar manner across both systems, leveraging heat exchange and mass transfer processes to achieve the desired cooling and desalination outcomes. Further, the integration of the ECC system 1502 and the DCMD system 1504, the circulation of the feed stream 150, and the flow of the refrigerant 120 within the desalination and cooling system 1500 are similar to those in the desalination and cooling system 1400. Furthermore, the desalination and cooling system 1500, similar to the desalination and cooling system 1400, maintains fluid connection of the feed stream 150 in an open. Also, the condenser 116 of the ECC system 1502 is tasked with further heating the feed stream 150. However, as illustrated in FIG. 15, the desalination and cooling system 1500 introduces some distinct features in comparison to the desalination and cooling system 1400. These features of the desalination and cooling system 1500, which are detailed in the subsequent paragraph(s), cater to specific operational requirements or environmental conditions, thereby extending the versatility and applicability of the desalination and cooling system 1500.

A feature of the desalination and cooling system 1500 lies in the usage of the heat exchanger 210 in conjunction with the condenser 116. Such that, the heat exchanger 210 utilizes the heating effect produced by the condenser 116. The heat exchanger 210 receives a feed water stream at the inlet 210a via the pump 151. The outlet 210b of the heat exchanger 210 provides the primary feed stream to the condenser 116. This primary feed stream 150 is heated by the condenser 116 and, is further transferred to the heater 510 and subsequently, to the feed chamber 152.

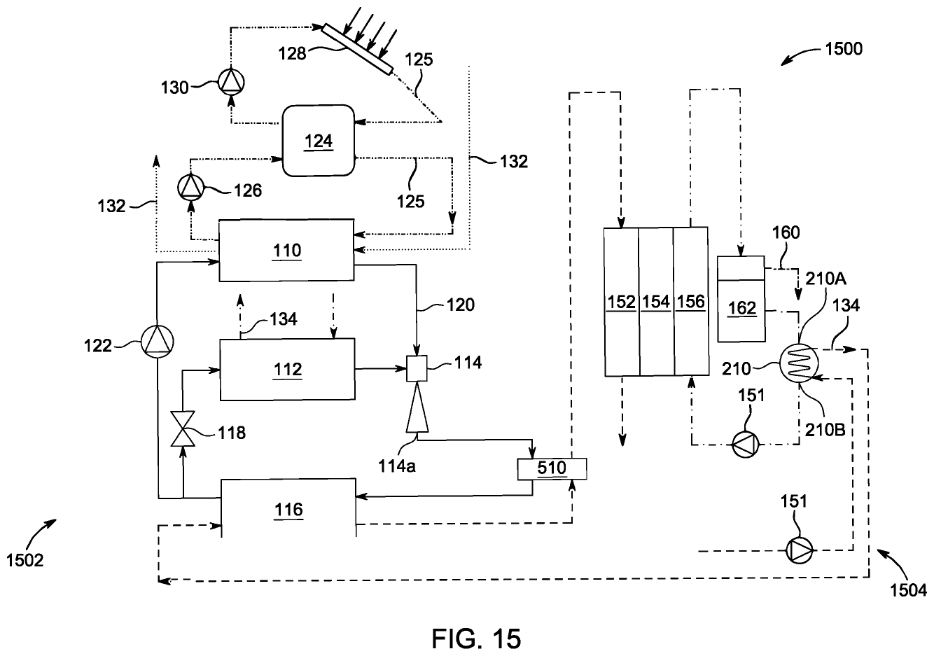

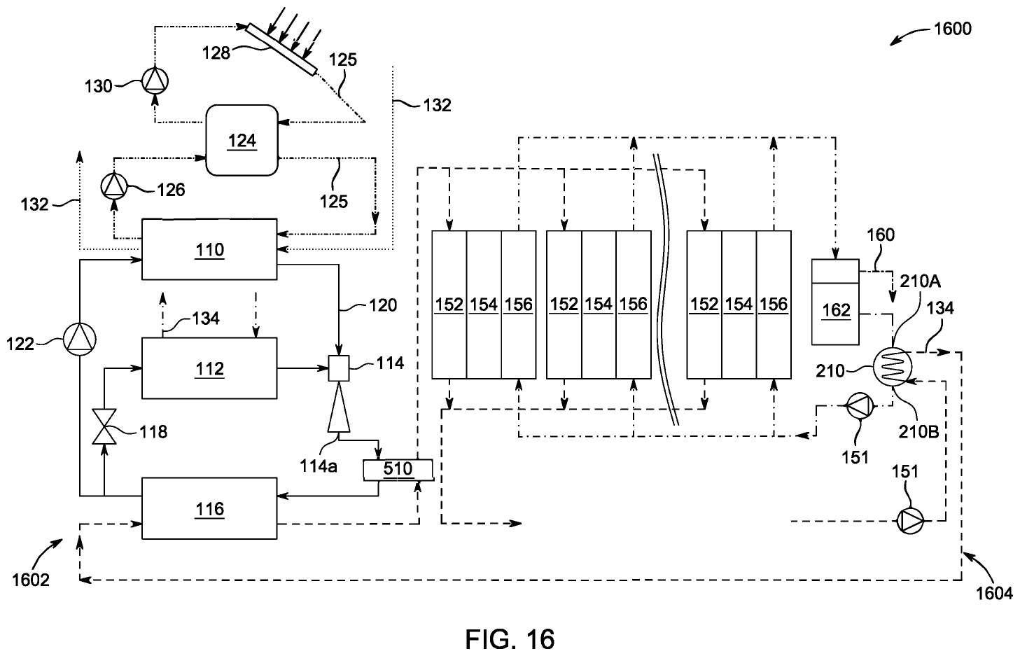

Referring to FIG. 16, illustrated is a schematic diagram of a desalination and cooling system 1600 having a multi-effect configuration, according to certain embodiments. The desalination and cooling system 1600 has many similarities with the desalination and cooling system 1200 depicted in FIG. 12, such as integrating an ECC system 1602 and a DCMD system 1604, combining principles of thermodynamic cycles and heat and mass transfer to produce freshwater and provide a cooling effect. The desalination and cooling system 1600 has the ECC system 1602 and the DCMD system 1604 with similar components to the desalination and cooling system 1200. These components interact, generally, in a similar manner across both systems, leveraging heat exchange and mass transfer processes to achieve the desired cooling and desalination outcomes. Further, the integration of the ECC system 1602 and the DCMD system 1604, the circulation of the feed stream 150, and the flow of the refrigerant 120 within the desalination and cooling system 1600 are similar to those in the desalination and cooling system 1200. Furthermore, the desalination and cooling system 1600, similar to the desalination and cooling system 1200, maintains fluid connection of the feed stream 150 in an open 150. Also, the condenser 116 of the ECC system 1602 is tasked with further heating the feed stream 150. However, as illustrated in FIG. 16, the desalination and cooling system 1600 introduces some distinct features in comparison to the desalination and cooling system 1200. These features of the desalination and cooling system 1600, which are detailed in the subsequent paragraph(s), cater to specific operational requirements or environmental conditions, thereby extending the versatility and applicability of the desalination and cooling system 1600.

A feature of the desalination and cooling system 1600, as illustrated in FIG. 16, is its multi-effect configuration while employing the heat exchanger 210 and the condenser 116 in conjunction. Specifically, in the desalination and cooling system 1600, the DCMD system 1604 has multi-effect configuration providing multiple DCMD units arranged in a staged manner, and each one including respective feed chamber 152, respective permeate chamber 156, and respective membrane 154. These multiple stages offer the opportunity for progressive and incremental heating, vapor generation, and condensation, thereby enhancing the overall efficiency and productivity of the desalination process. It may be understood that the desalination and cooling system 1600 utilizes a single ECC system 1602. Herein, the DCMD system 1604 may have the multiple DCMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the DCMD system 1604. The multi-effect configuration provides the desalination and cooling system 1600 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple permeate chambers 156 allows for precise control over the temperature and flow rates at each stage, enhancing both the desalination and cooling efficiencies of the desalination and cooling system 1600.

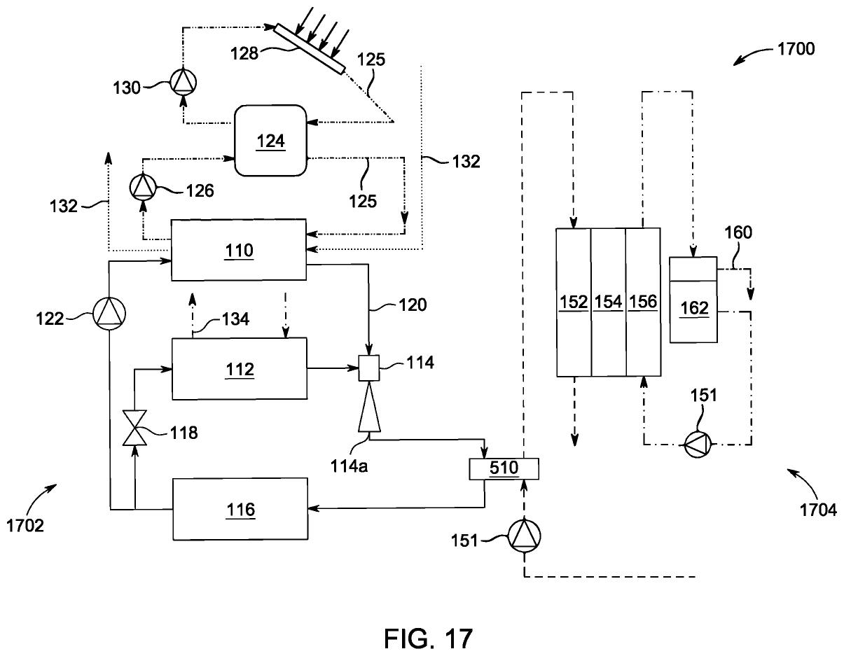

Referring to FIG. 17, illustrated is a schematic diagram of a desalination and cooling system 1700 having a single-effect configuration, according to certain embodiments. The desalination and cooling system 1700 has many similarities with the desalination and cooling system 1300 depicted in FIG. 13, such as integrating an ECC system 1702 and a DCMD system 1704, combining principles of thermodynamic cycles and heat and mass transfer to produce freshwater and provide a cooling effect. The desalination and cooling system 1700 has the ECC system 1702 and the DCMD system 1704 with similar components to the desalination and cooling system 1300. These components interact, generally, in a similar manner across both systems, leveraging heat exchange and mass transfer processes to achieve the desired cooling and desalination outcomes. Further, the integration of the ECC system 1702 and the DCMD system 1704, the circulation of the feed stream 150, and the flow of the refrigerant 120 within the desalination and cooling system 1700 are similar to those in the desalination and cooling system 1300. Furthermore, the desalination and cooling system 1700, similar to the desalination and cooling system 1300, maintains fluid connection of the feed stream 150 in an open loop and employs the permeate chamber 156 of the DCMD system 1704 for pre-heating the feed stream 150. Also, the desalination and cooling system 1700 has the heater 510 located at the outlet 114a of the ejector 114 of the ECC system 1702, providing additional heating to the feed stream 150. However, as illustrated in FIG. 17, the desalination and cooling system 1700 introduces some distinct features in comparison to the desalination and cooling system 1300. These features of the desalination and cooling system 1700, which are detailed in the subsequent paragraph(s), cater to specific operational requirements or environmental conditions, thereby extending the versatility and applicability of the desalination and cooling system 1700.

A feature of the desalination and cooling system 1700, as illustrated in FIG. 17, is that the condenser 116 of the ECC system 1702 is not used (at least directly) for heating the feed stream 150, but the heater 510 is solely and directly used for such purpose. The heater 510 directly heats the feed stream 150, elevating its temperature before it enters the feed chamber 152 of the DCMD system 1704. The direct heating from the heater 510 may lead to more efficient vapor generation, resulting in improved desalination productivity.

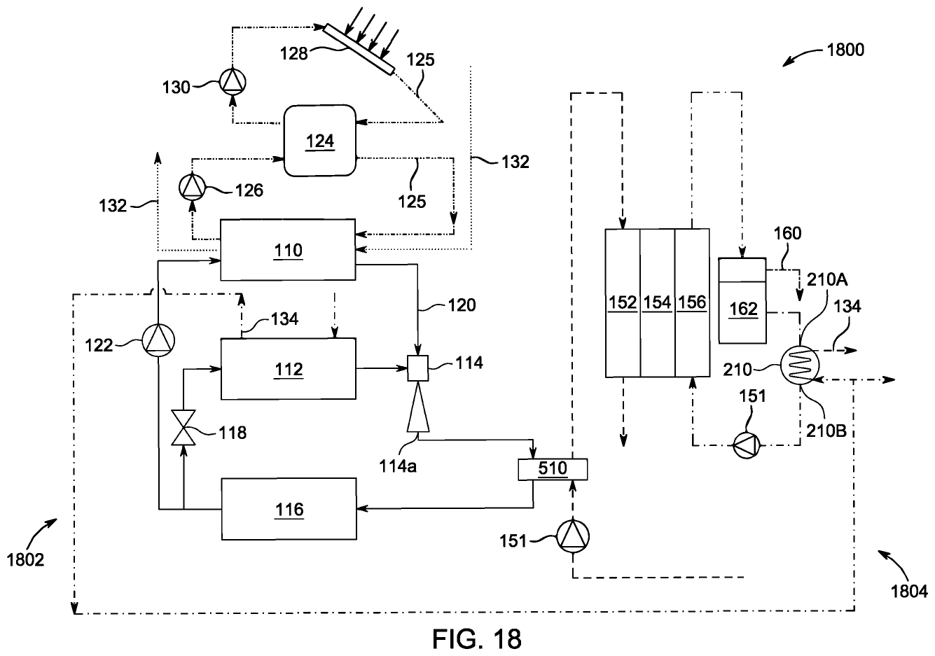

Referring to FIG. 18, illustrated is a schematic diagram of a desalination and cooling system 1800 having a single-effect configuration, according to certain embodiments. The desalination and cooling system 1800 has many similarities with the desalination and cooling system 1700 depicted in FIG. 17, such as integrating an ECC system 1802 and a DCMD system 1804, combining principles of thermodynamic cycles and heat and mass transfer to produce freshwater and provide a cooling effect. The desalination and cooling system 1800 has the ECC system 1802 and the DCMD system 1804 with similar components to the desalination and cooling system 1700 except for the inclusion of the heat exchanger 210. These components interact, generally, in a similar manner across both systems, leveraging heat exchange and mass transfer processes to achieve the desired cooling and desalination outcomes. Further, the integration of the ECC system 1802 and the DCMD system 1804, the circulation of the feed stream 150, and the flow of the refrigerant 120 within the desalination and cooling system 1800 are similar to those in the desalination and cooling system 1700. Furthermore, the desalination and cooling system 1800, similar to the desalination and cooling system 1700, maintains fluid connection of the feed stream 150 in an open loop a. Also, the desalination and cooling system 1800 has the heater 510 located at the outlet 114a of the ejector 114 of the ECC system 1802, providing additional heating to the feed stream 150. Further, herein as well, the desalination and cooling system 1800 does not use the condenser 116 of the ECC system 1802 (at least directly) for heating the feed stream 150, but the heater 510 is solely and directly used for such purpose. However, as illustrated in FIG. 18, the desalination and cooling system 1800 introduces some distinct features in comparison to the desalination and cooling system 1700. These features of the desalination and cooling system 1800, which are detailed in the subsequent paragraph(s), cater to specific operational requirements or environmental conditions, thereby extending the versatility and applicability of the desalination and cooling system 1800.

A feature of the desalination and cooling system 1800, as illustrated in FIG. 18, is its dual functionality of both heating the feed stream 150 via the heater 510 and cooling the heat exchanger 210 via the evaporator 112, achieved through the integration of the heater 510 at the outlet 114a to the ejector 114 of the ECC system 1802 and the utilization of the cooling effect 134 provided by the evaporator 112 of the ECC system 1802. Similar to the desalination and cooling system 1700, the desalination and cooling system 1800 incorporates the heating stage through the inclusion of the heater 510. The heater 510 directly heats the feed stream 150, elevating its temperature before it enters the feed chamber 152 of the DCMD system 1804. The direct heating from the heater 510 may lead to more efficient vapor generation, resulting in improved desalination productivity. Additionally, the desalination and cooling system 1800 also takes advantage of the cooling effect 134 produced by the evaporator 112 of the ECC system 1802. A portion of the cooling effect 134 is utilized to cool the heat exchanger 210, which helps manage the thermal load and enhances the overall energy efficiency of the desalination and cooling system 1800. The dual functionality of the desalination and cooling system 1800, providing additional heating to the feed stream 150 entering the feed chamber 152 while also cooling the heat exchanger, gives it a distinctive operational advantage. The desalination and cooling system 1800 not only improves the conditions for vapor generation in the DCMD system 1804, but also effectively manages the thermal conditions of the feed stream 150, which may lead to a more efficient and productive desalination process.

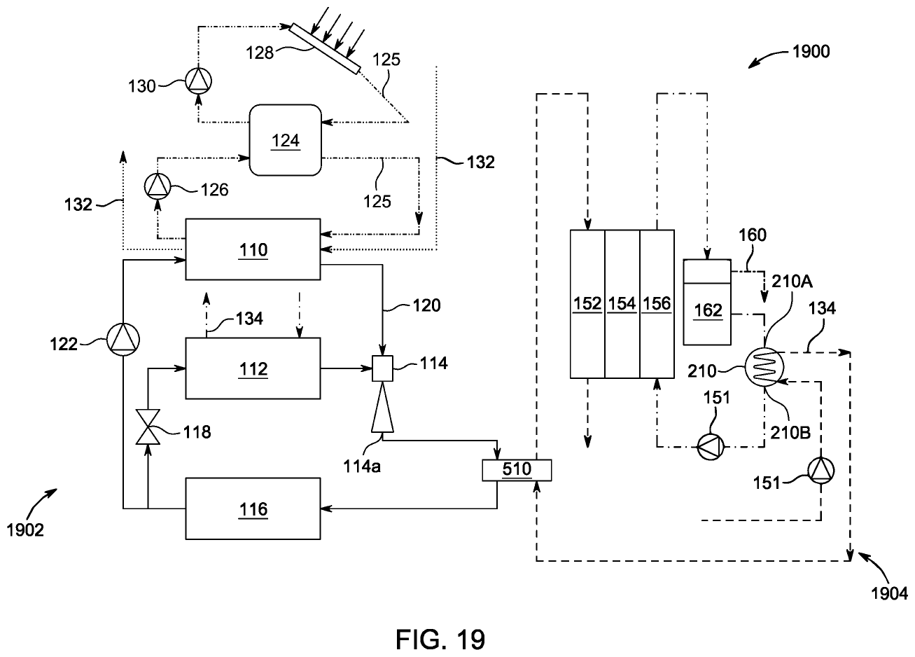

Referring to FIG. 19, illustrated is a schematic diagram of a desalination and cooling system 1900 having a single-effect configuration, according to certain embodiments. The desalination and cooling system 1900 has many similarities with the desalination and cooling system 1800 depicted in FIG. 18, such as integrating an ECC system 1902 and a DCMD system 1904, combining principles of thermodynamic cycles and heat and mass transfer to produce freshwater and provide a cooling effect. The desalination and cooling system 1900 has the ECC system 1902 and the DCMD system 1904 with similar components to the desalination and cooling system 1800. These components interact, generally, in a similar manner across both systems, leveraging heat exchange and mass transfer processes to achieve the desired cooling and desalination outcomes. Further, the integration of the ECC system 1902 and the DCMD system 1904, the circulation of the feed stream 190, and the flow of the refrigerant 120 within the desalination and cooling system 1900 are similar to those in the desalination and cooling system 1800. Furthermore, the desalination and cooling system 1900, similar to the desalination and cooling system 1800, maintains fluid connection of the feed stream 150 in an open loop 150. Also, the desalination and cooling system 1900 has the heater 510 located at the outlet 114a of the ejector 114 of the ECC system 1902, providing additional heating to the feed stream 150. Further, herein as well, the desalination and cooling system 1900 does not use the condenser 116 of the ECC system 1802 (at least directly) for heating the feed stream 150, but the heater 510 is solely and directly used for such purpose. However, as illustrated in FIG. 19, the desalination and cooling system 1900 introduces some distinct features in comparison to the desalination and cooling system 1800. These features of the desalination and cooling system 1900, which are detailed in the subsequent paragraph(s), cater to specific operational requirements or environmental conditions, thereby extending the versatility and applicability of the desalination and cooling system 1900.

A feature of the desalination and cooling system 1900 lies in the conjunction of the heat exchanger 210 with the heater 510 directly, unlike the conjunction of the heat exchanger with the condenser 116 in the desalination and cooling system 1800. The heat exchanger 210 receives the feed water stream at the inlet 210 via the pump 151. The outlet 210b of the heat exchanger 210 provides the primary feed stream 150 to the heater 510. The primary feed stream 150 is heated by the heater 510 and, is further transferred to the feed chamber 152. The inclusion of heat exchanger 210 and the heater 510 in such a setup allows the desalination and cooling system to achieve higher efficiency.

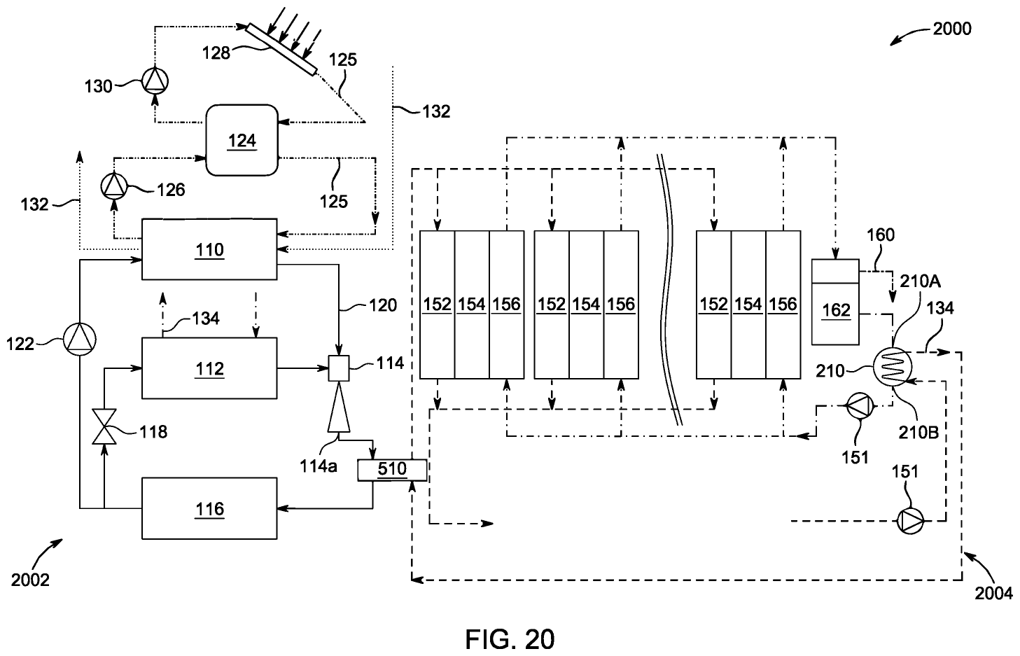

Referring to FIG. 20, illustrated is a schematic diagram of a desalination and cooling system 2000 having a multi-effect configuration, according to certain embodiments. The desalination and cooling system 2000 has many similarities with the desalination and cooling system 1900 depicted in FIG. 19, such as integrating an ECC system 2002 and a DCMD system 2004, combining principles of thermodynamic cycles and heat and mass transfer to produce freshwater and provide a cooling effect. The desalination and cooling system 2000 has the ECC system 2002 and the DCMD system 2004 with similar components to the desalination and cooling system 1900. These components interact, generally, in a similar manner across both systems, leveraging heat exchange and mass transfer processes to achieve the desired cooling and desalination outcomes. Further, the integration of the ECC system 2002 and the DCMD system 2004, the circulation of the feed stream 150, and the flow of the refrigerant 120 within the desalination and cooling system 2000 are similar to those in the desalination and cooling system 1900. Furthermore, the desalination and cooling system 2000, similar to the desalination and cooling system 1600, maintains fluid connection of the feed stream 150 in an open. Also, the desalination and cooling system 2000 has the heater 510 located at the outlet 114a of the ejector 114 of the ECC system 2002, providing additional heating to the feed stream 150. Further, herein as well, the desalination and cooling system 2000 does not use the condenser 116 of the ECC system 2002 (at least directly) for heating the feed stream 150, but the heater 510 is solely and directly used for such purpose. However, as illustrated in FIG. 20, the desalination and cooling system 2000 introduces some distinct features in comparison to the desalination and cooling system 1900. These features of the desalination and cooling system 2000, which are detailed in the subsequent paragraph(s), cater to specific operational requirements or environmental conditions, thereby extending the versatility and applicability of the desalination and cooling system 2000.

A feature of the desalination and cooling system 2000, as illustrated in FIG. 20, is its multi-effect configuration. Specifically, in the desalination and cooling system 2000, the DCMD system 2004 has multi-effect configuration providing multiple DCMD units arranged in a staged manner, and each one including respective feed chamber 152, respective permeate chamber 156 and respective membrane 154. These multiple stages offer the opportunity for progressive and incremental heating, vapor generation, and condensation, thereby enhancing the overall efficiency and productivity of the desalination process. It may be understood that the desalination and cooling system 2000 utilizes a single ECC system 2002. Herein, the DCMD system 2004 may have the multiple DCMD units arranged in various configurations such as series, parallel, or a combination of both. In the series configuration, the flow rate of the feed stream 150 entering each subsequent stage is reduced by the amount of the distillate produced in the preceding stage. Further, the temperature of the feed stream 150 entering the next stage is lower than the temperature of the preceding stage. This configuration allows for a sequential, step-by-step process of desalination where each stage progressively concentrates the feed stream 150. On the other hand, in the parallel configuration, the feed stream 150 enters each stage at a consistent rate and constant temperature. This configuration provides simultaneous desalination across all stages, allowing for a higher overall throughput and potentially improved efficiency of the DCMD system 2004. The multi-effect configuration provides the desalination and cooling system 2000 with enhanced capabilities in terms of energy efficiency, desalination productivity, and thermal management. With such configuration, it may be possible to use different membrane materials at each stage, which may be improved based on the temperature and concentration conditions at each stage, leading to improved performance. Similarly, the use of multiple feed chambers 152 and multiple permeate chambers 156 allows for precise control over the temperature and flow rates at each stage, enhancing both the desalination and cooling efficiencies of the desalination and cooling system 2000.

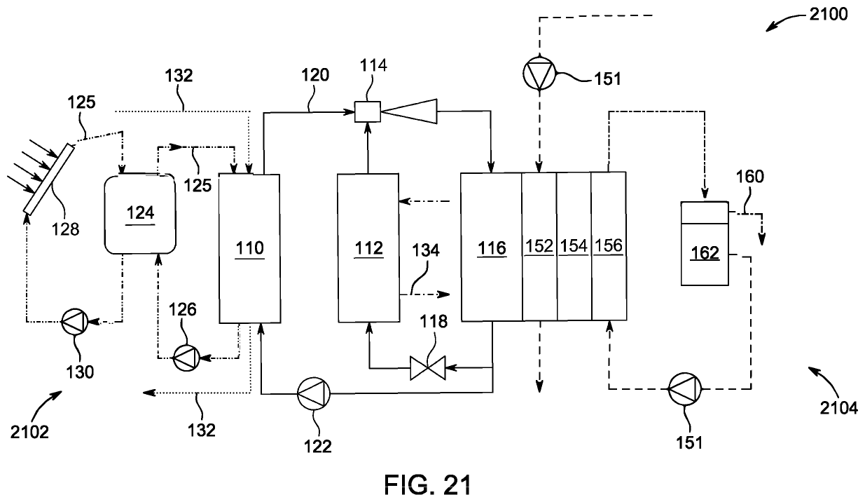

Referring to FIG. 21, illustrated is a schematic diagram of a desalination and cooling system 2100 having a single-effect configuration, according to certain embodiments. The desalination and cooling system 2100 integrates an ECC system 2102 and a DCMD system 2104 in a single-effect configuration, designed to provide efficient desalination and cooling functionalities. As with the previously discussed embodiments, the desalination and cooling system 2100 operates with the feed stream 150 to be treated that is fluidly connected in an open loop. The ECC system 2102 in the desalination and cooling system 2100 includes components such as the generator 110, the ejector 114, and the condenser 116. The refrigerant 120 flows through these components in a cycle, absorbing and releasing heat energy, and thus generating a cooling effect.

A feature of the desalination and cooling system 2100, as illustrated in FIG. 21, is a direct contact heat exchanger between the condenser 116 of the ECC system 2102 and the feed chamber 152 of the DCMD system 2104. This arrangement allows for the direct transfer of heat from the condenser 116 to the feed stream 150, thereby elevating its temperature. The heated feed stream 150 in the feed chamber 152 of DCMD system 2102 may then produce water vapor at the interface with the membrane 154. The water vapor permeates across the pores of the membrane 154 and condenses in the external cooling source 162 due to the cooler conditions maintained by the external cooling source 162. The direct contact heat exchange between the condenser 116 and the feed chamber 152 enhances the heat transfer efficiency, leading to improved vapor generation and thus improved desalination efficiency. This feature also simplifies the configuration for the desalination and cooling system 2100, and reduces thermal losses, enhancing the overall energy efficiency of the desalination and cooling system 2100.

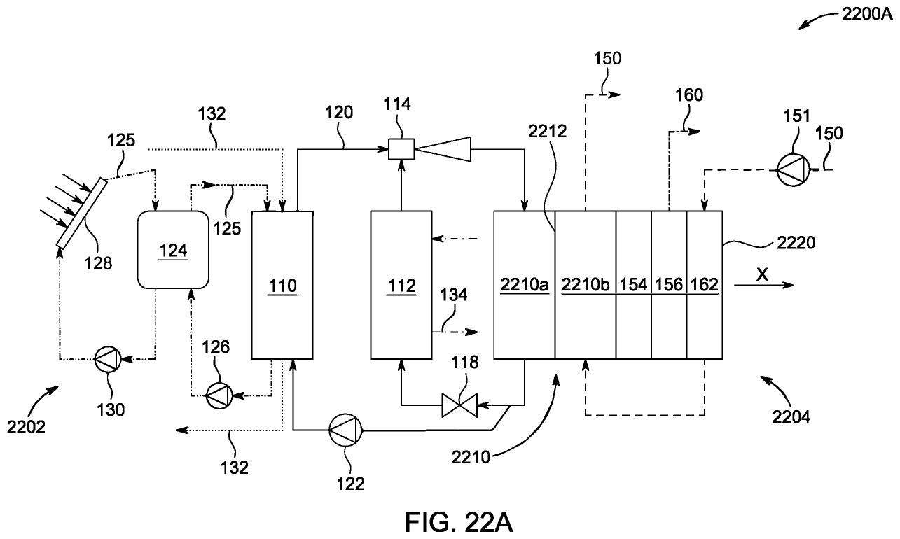

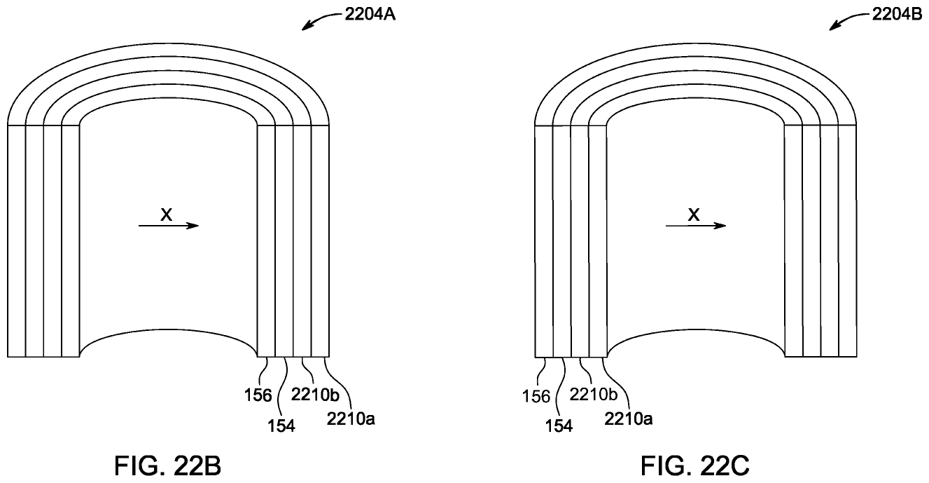

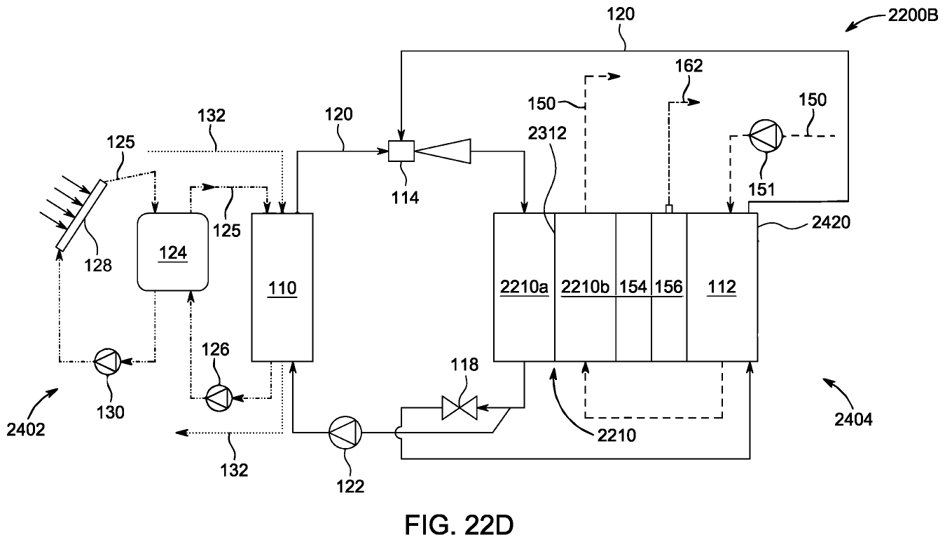

Referring to FIG. 22A, illustrated is a schematic diagram of a desalination and cooling system 2200A having a single-effect configuration, according to certain embodiments. The desalination and cooling system 2200A integrates an ECC system 2202 and a DCMD system 2204 in a single-effect configuration, designed to provide efficient desalination and cooling functionalities. As with the previously discussed embodiments, the desalination and cooling system 2200A operates with the feed stream 150 to be treated that is fluidly connected in an open loop. In the ECC system 2204, the generator 110 is configured to generate the primary flow of the refrigerant 120. The evaporator 112 is designed to provide cooling and to generate the secondary flow of the refrigerant 120. The ejector 114 is configured for the primary and secondary flows of the refrigerant 120 to pass through and produce the super-heated stream of the refrigerant 120.

A feature of the desalination and cooling system 2200A, as illustrated in FIG. 22A, is a design of a condenser 2210 in the ECC system 2202. The condenser 2210 is designed to cool the super-heated stream of the refrigerant 120. The condenser 2210 includes a wall 2212 that separates a hot medium compartment 2210a and a cold medium compartment 2210b. The hot medium compartment 2210a is configured to receive the super-heated stream of the refrigerant 120. In the DCMD system 2204, the cold medium compartment 2210b of the condenser 2210 of the ECC system 2202 is designed to receive the feed stream 150 optionally from the external cooling source 162. The membrane 154, including a plurality of pores, is positioned between the cold medium compartment 2210b and the permeate chamber 156. The membrane 154 is designed to allow water vapors to pass from the cold medium compartment 2210b through the membrane 154 to the permeate chamber 156. This design of the condenser 2210 allows for efficient heat transfer between the hot medium compartment 2210a, which houses the super-heated refrigerant 120, and the cold medium compartment 2210b, which houses the feed stream 150. This direct heat exchange process results in the generation of water vapors from the feed stream 150, which then pass through the membrane 154 into the permeate chamber 156, providing an efficient process for water desalination.

Also, as illustrated in FIG. 22A, the desalination and cooling system 2200A further includes an enclosure 2220, that encompasses several components of the desalination and cooling system 2200A. These components include the hot medium compartment 2210a, the cold medium compartment 2210b, the membrane 154, the permeate chamber 156, and the external cooling source 162. The enclosure 2220 serves as a physical boundary that effectively houses and protects these components, ensuring their functioning and longevity. By consolidating these elements within the enclosure 2220, the desalination and cooling system 2200A benefits from a streamlined and compact design that makes it versatile and adaptable to a variety of installation environments.

Further, the enclosure 2220 is designed to not only protect the components but also to facilitate their interactions. For this purpose, the hot medium compartment 2210a, the cold medium compartment 2210b, the membrane 154, and the permeate chamber 156 are all arranged in succession within the enclosure 2220. This sequential arrangement allows the components to function in tandem, promoting the efficient flow and transfer of heat and mass within the desalination and cooling system 2200A. The layout further ensures that the feed stream 150 and the refrigerant 120 traverse through the desalination and cooling system 2200A in a functional sequence, enabling the desalination and cooling system 2200A to perform its intended functions efficiently.

In particular, starting from the hot medium compartment 2210a, the super-heated stream of the refrigerant 120, generated by the ejector 114, enters the hot medium compartment 2210a and releases its heat, thereby cooling down. The heat is transferred across the wall 2212 to the cold medium compartment 2210b, where the feed stream 150 gets further heated, and water vapors are generated. These water vapors pass through the membrane 154 to reach the permeate chamber 156, where the vapors are cooled down and further transferred to the external cooling source 162 and condenses into liquid form, thereby completing the desalination process. At the same time, the cold feed stream 150 gets pre-heated, thereby closing the loop and ensuring the efficient use of heat within the desalination and cooling system 2200A. Thus, the enclosure 2220 having the sequential arrangement of the hot medium compartment 2210a, the cold medium compartment 2210b, the membrane 154, and the permeate chamber 156 therein, forms an efficient, self-contained unit for the desalination and cooling system 2200A. This design ensures improved heat and mass transfer, thereby enhancing the overall energy efficiency of the desalination and cooling system 2200A.

In certain embodiments, the DCMD system 2204, or specifically the enclosure 2220 has a geometrical configuration in which the permeate chamber 156, the membrane 154, the cold medium compartment 2210b, and the hot medium compartment 2210a are all cylindrical and concentrically arranged in succession along a radial direction ‘X’ (as shown). This concentric cylindrical arrangement improves the surface area available for heat and mass transfer, thereby improving the efficiency of the DCMD system 2204. The cylindrical shape of the components also contributes to the compactness of the DCMD system 2204, allowing for a more flexible installation. Such design may be implemented in two different configurations. In a first configuration, the arrangement of these components starts from the innermost cylinder and expands outward. In the second configuration, the arrangement starts from the outermost cylinder and progresses inward.

FIG. 22B provides a cross-section diagram of the DCMD system (represented by reference numeral 2204A) for the desalination and cooling system 2200A, according to the said first configuration. Herein, the permeate chamber 156 forms an inner cylinder, the membrane 154, the cold medium compartment 2210b, and finally, the hot medium compartment 2210a as an outer cylinder.

FIG. 22C provides a cross-section diagram of the DCMD system (represented by reference numeral 2204B) for the desalination and cooling system 2200A, according to the said second configuration. Herein, the hot medium compartment 2210a forms an inner cylinder, followed by the cold medium compartment 2210b, the membrane 154, and finally, the permeate chamber 156 as an outer cylinder.

Both configurations leverage the cylindrical and concentric design to ensure efficient heat and mass transfer for the functioning of the desalination and cooling system 2200A. The choice between the two configurations may be determined based on specific application requirements, available space, and other design considerations.

Referring to FIG. 22D, illustrated is a schematic diagram of a desalination and cooling system 2200B having a single-effect configuration, according to certain embodiments. The desalination and cooling system 2200B integrates an ECC system 2402 and a DCMD system 2404 in a single-effect configuration, designed to provide efficient desalination and cooling functionalities. As with the previously discussed embodiments, the desalination and cooling system 2200B operates with the feed stream 150 to be treated that is fluidly connected in an open loop. The feed stream 150 initially undergoes pre-heating in the coolant chamber 154 of the DCMD system 2404. This pre-heating prepares the feed stream 150 for the subsequent distillation process and also ensures that the coolant chamber 154 provides the necessary low temperature to maintain the optimal conditions for the DCMD system 2404.

In the ECC system 2402, the condenser 2210 (as in FIG. 22A) is present that includes the hot medium compartment 2210a and the cold medium compartment 2210b. Note that the cold medium compartment 2210b receives the feed stream 150 from the evaporator 112 and utilizes the thermal energy from the hot medium compartment 2210a to heat the feed stream 150 within the DCMD system 2404. In an alternative embodiment, the feed stream 150 directly enters the cold medium compartment 2210b. The evaporator 112 cools down the permeate chamber 156.

Herein, as illustrated, the desalination and cooling system 2200B incorporates the evaporator 112 of the ECC system 2402 with the DCMD system 2404, to provide the cooling effect therefor. In an example, the evaporator 112 may be part of an enclosure 2420 of the DCMD system 2404. Unlike the previously discussed embodiments, in the desalination and cooling system 2200B, the cooling effect from the evaporator 112 is utilized directly to cool the permeate chamber 156 within the DCMD system 2404. That is, the feed stream 150 may be pumped directly into the evaporator 112, which may get cooled for further use in the DCMD system 2404. This additional cooling step may help enhance the performance of the DCMD system 2404, particularly in scenarios where the ambient temperature is high or the feed stream 150 is warmer than desired for efficient operation of the DCMD system 2404. In other words, the evaporator 112 herein performs functions of both the evaporator 112 and the external cooling source 162 in FIGS. 22A and 21. The rest of the ECC system 2402 and the DCMD system 2404 may operate in the same manner as described earlier in the context of the previously discussed embodiments.

Similar to FIGS. 22A-22C, an enclosure 2420 herein, which corresponds to the enclosure 2220, can encompass several components of the desalination and cooling system 2200B. These components include the hot medium compartment 2210a, the cold medium compartment 2210b, the membrane 154, the permeate chamber 156 and the evaporator 112. The enclosure 2420 can serve as a physical boundary that effectively houses and protect these components, ensuring their synergistic functioning and longevity. By consolidating these elements within the enclosure 2420, the desalination and cooling system 2200B benefits from a streamlined and compact design that makes it versatile and adaptable to a variety of installation environments.

Further, the enclosure 2420 is designed to not only protect the components but also to facilitate their interactions. For this purpose, the hot medium compartment 2210a, the cold medium compartment 2210b, the membrane 154, the permeate chamber 156, and the evaporator 112 are all arranged in succession within the enclosure 2420. This sequential arrangement allows the components to function in tandem, promoting the efficient flow and transfer of heat and mass within the desalination and cooling system 2200B while reducing the number of inlets, outlets and/or connecting pipes. The layout further ensures that the feed stream 150 and the refrigerant 120 traverse through the desalination and cooling system 2200B in an optimal sequence, enabling the desalination and cooling system 2200B to perform its intended functions efficiently.

In one embodiment, the DCMD system 2404 for the desalination and cooling system 2200B can be similar to the numeral 2204A in FIG. 22B and are not shown for simplicity purposes. That is, the evaporator 112 forms an inner cylinder, followed by the permeate chamber 156, the membrane 154, the cold medium compartment 2210b, and the hot medium compartment 2210a as an outer cylinder. This arrangement allows the feed stream 150 to be cooled by the evaporator 112 and then heated by the super-heated stream of the refrigerant 120 in various compartments moving radially outward from the evaporator 112 to the hot medium compartment 2210a.

In another embodiment, the DCMD system 2404 for the desalination and cooling system 2200B can be similar to the numeral 2204B in FIG. 22C and are not shown for simplicity purposes. That is, the hot medium compartment 2210a forms an inner cylinder, followed by the cold medium compartment 2210b, the membrane 154, the permeate chamber 156, and the evaporator 112 as an outer cylinder. This arrangement allows the feed stream 150 to be cooled by the evaporator 112 and then heated by the super-heated stream of the refrigerant 120 in various compartments moving radially inward from the evaporator 112 to the hot medium compartment 2210a.

The present disclosure further provides experimental data obtained from testing the desalination and cooling system 100 of FIG. 1 (taken as reference) as per embodiments of the present disclosure. The experimental setup was modeled based on the desalination and cooling system 100, which shows the ECC system 102 hybridized with the DCMD system 104.

In some embodiments, the membrane 158 has an effective area of 0.1-1.0 m², preferably 0.3-0.8 m², preferably 0.4-0.6 m², a mean pore size of 0.1-1.0 μm, preferably 0.3-0.8 μm, preferably 0.4-0.6 μm, a thickness of 100-200 μm, preferably 120-180 μm, preferably 140-160 μm, and a porosity of 60-99%, preferably 70-90%, preferably 75-85%.

In one experimental setup, the waste heat from the condenser 116 is recovered and utilized to elevate the temperature of the intake feed stream 150. The membrane 154 used in this model has an effective area of 0.5 m² and a mean pore size of 0.45 μm. Thickness and porosity of the membrane 154 are assumed to be 153 μm and 80%, respectively. The feed chamber 152 and the permeate chamber 156 of the DCMD system 104 can be of equal dimensions, measuring 0.5-3.0 m, preferably 0.7-2.0 m, preferably 1 m in length, 0.2-1.0 m, preferably 0.4-0.7 m, preferably 0.5 m in width, and 0.0001-0.0080 m, preferably 0.0005-0.0020 m, preferably 0.001 m in depth. The feed stream 150 to be treated is assumed to have a salinity of 10,000-60,000 mg/L, preferably 20,000-40,000 mg/L, preferably 35,000 mg/L. Flow rates of the feed stream 150 and the coolant stream are each selected to be 1-10 L/min, preferably 2.5 L/min, preferably 5 L/min. Initial temperature of the feed stream 150 is assumed to be 5-50° C., preferably 20-35° C., preferably 27° C., and maximum temperature of the feed stream 150 after heating in the condenser 116 depends on the type of refrigerant used in the ECC system 102. Further, temperature of the coolant stream is fixed at 5-23° C., preferably 10-22° C., preferably 20° C. Efficiency of the condenser 116 is assumed to be 70-100%, preferably 80-95%, preferably 90%, and each pump has an assumed efficiency of 70-100%, preferably 80-95%, preferably 90%. The refrigerants used in the ECC system 102 may include, but are not limited to, R718, R600a, and R245fa. Further, temperature of the evaporator 112 is 5-20° C., preferably 8-15° C., preferably 12° C. Temperature of the generator 110 is 70-150° C., preferably 80-130° C., preferably 90° C. Temperature of the condenser 116 is 20-50° C., preferably 30-40° C., preferably 34.2° C. The performance of the desalination and cooling system 100 is evaluated in terms of gained output ratio (GOR), and energy utilization factor (EUF), productivity, and cooling effect.

Herein, the GOR is calculated as the ratio of the latent heat of vaporization of the produced freshwater 160 to the sum of input energy to the generator 110 and energy consumed by the pumps. The GOR of the desalination and cooling system 100 represents the energy efficiency of the standalone DCMD system and can be expressed as:

$$GOR = \frac{{\dot{Q}}_{D C MD , useful}}{{\dot{Q}}_{G e n e r a t o r} + {\dot{W}}_{Pumps}} \qquad ( 1 )$$

Further, useful energy in the DCMD system 104 is related to the evaporation process, and can be expressed as:

$${\dot{Q}}_{DCMD , useful} = J \times Δ {H}_{v} \times {A}_{m} \qquad ( 2 )$$

where J, ΔHᵥ, and Aₘ is the DCMD permeate flux (kg/m² h), latent heat of vaporization (kJ/kg), and membrane active area, respectively.

Also, the EUF is calculated as the ratio of the sum of the latent heat of vaporization of the produced freshwater 160 and the cooling effect 134 in the evaporator 112 to the sum of the input energy to the generator 110 and the energy consumed by the pumps. The EUF of the desalination and cooling system 100 represents its energy efficiency and can be given as:

$$EUF = \frac{{\dot{Q}}_{DCMD , useful} + {\dot{Q}}_{Evaporator}}{{\dot{Q}}_{G e n e r a t o r} + {\dot{W}}_{Pumps}} \qquad ( 3 )$$

Further, the productivity of the desalination and cooling system 100 is the freshwater 160 produced (L/day) by the DCMD system 104 therein, while the cooling effect of the desalination and cooling system 100 is the cooling effect 134 (refrigeration load) (in W) produced in the evaporator 112 of the ECC system 102 therein.

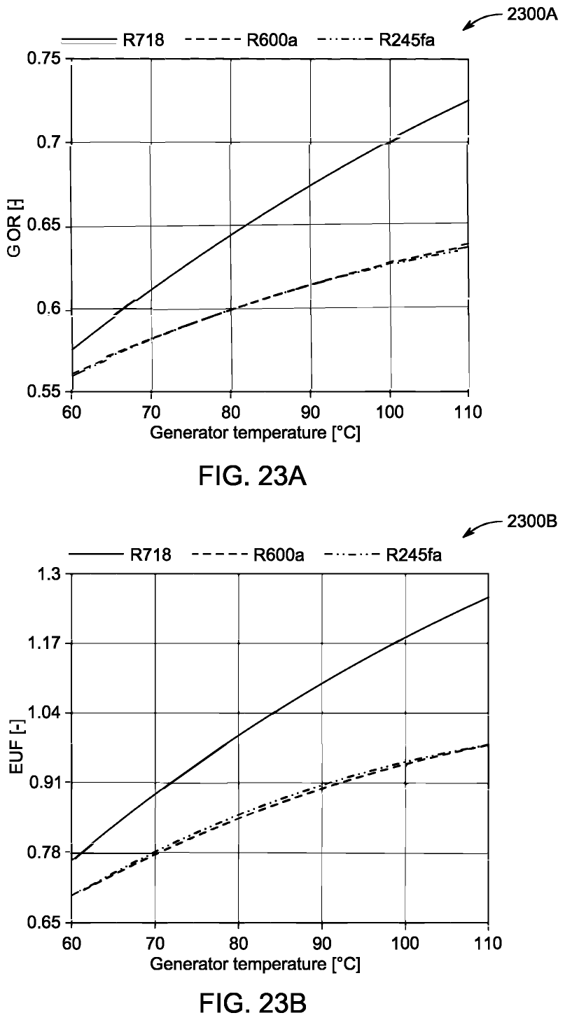

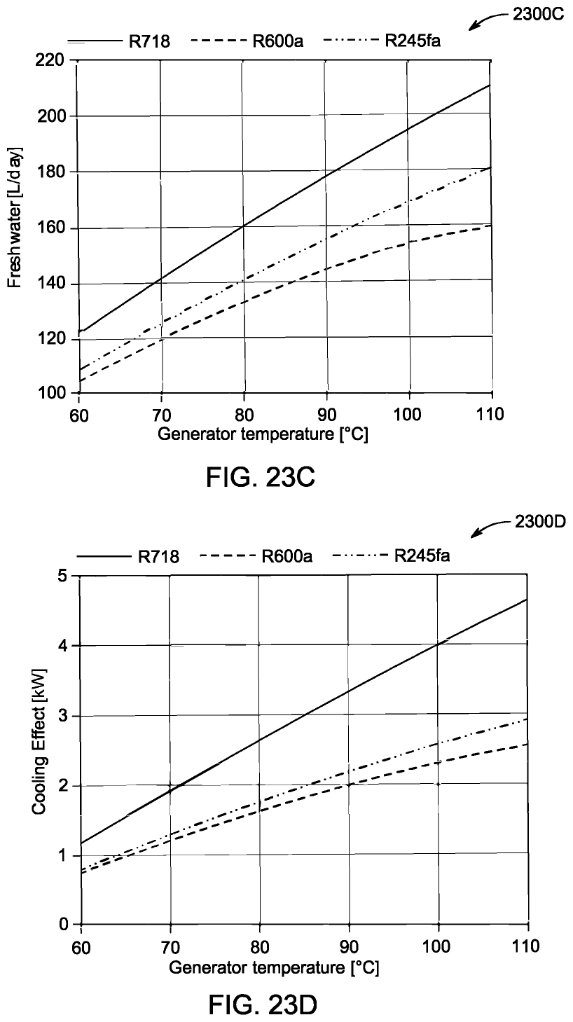

Referring to FIGS. 23A-23D, illustrated are graphs 2300A-2300D representing the GOR, the EUF, the freshwater produced, and the cooling effect produced, respectively, for evaluating the performance of the desalination and cooling system 100 at different temperatures of the generator 110 of the ECC system 102 therein. The graph 2300A shows the GOR, demonstrating that as temperature of the generator 110 increases, the GOR also increases for different refrigerants used in the cycle. The GOR, indicative of the energy efficiency of the standalone DCMD system, achieves its highest value of 0.7236 at a temperature of the generator 110 of 110° C. with the R718 refrigerant. The graph 2300B shows the EUF, which also increases with the rise in the temperature of the generator 110. The EUF, which represents the energy efficiency of the desalination and cooling system 100, peaks at 1.257 with the R718 refrigerant at a temperature of the generator 110 of 110° C. The graph 2300C shows the freshwater production of the desalination and cooling system 100, which also increases with the temperature of the generator 110. The desalination and cooling system 100 reaches its highest freshwater production of 210 L/day at a temperature of the generator 110 of 110° C. with the R718 refrigerant. The graph 2300D shows the cooling effect produced by the desalination and cooling system 100, which increases as the temperature of the generator 110 increases. The maximum cooling effect, 4621 W, is achieved at a temperature of the generator 110 of 110° C. using the R718 refrigerant.

It may be noted that the integration of the DCMD system 104 with the ECC system 102 enhances energy efficiency of the DCMD system 104 in the desalination and cooling system 100 by over 73% when compared to the standalone DCMD system, as indicated by the maximum GOR and EUF. The R718 refrigerant yields superior performance due to its ability to recover more waste heat from the condenser 116 of the ECC system 102. This increased recovery results in a higher transmembrane temperature in the DCMD system 104, which in turn leads to a higher driving force for vapor permeation, increased water flux, and consequently, improved energy efficiency of the desalination and cooling system 100.

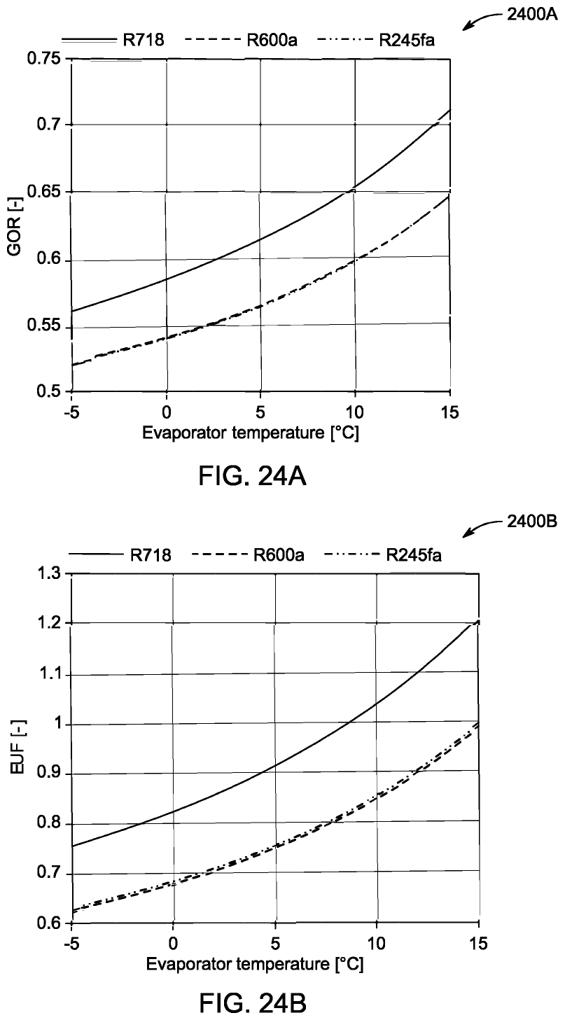

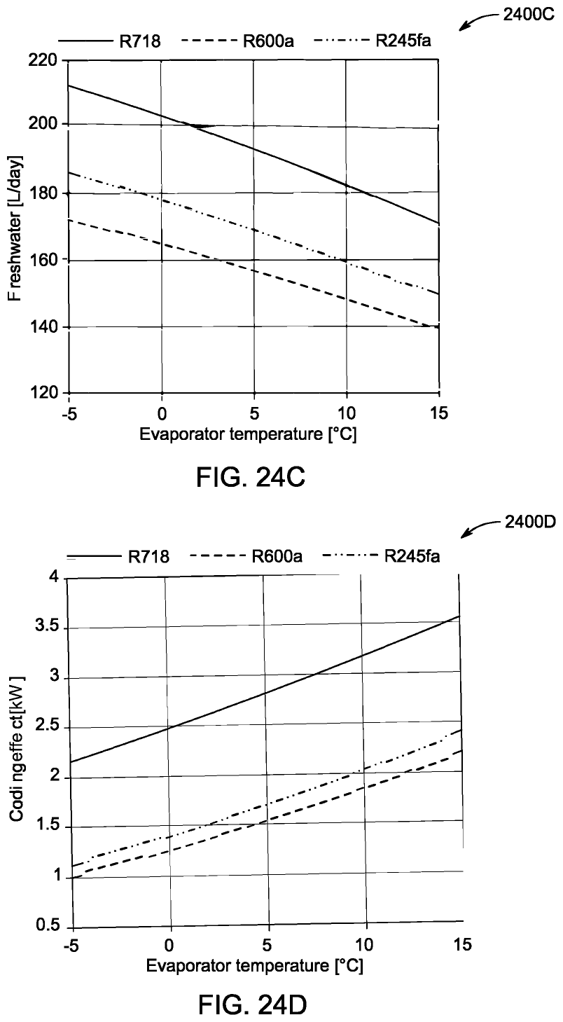

Referring to FIGS. 24A-24D, illustrated are graphs 2400A-2400D depicting the GOR, EUF, freshwater production, and cooling effect, respectively, for the evaluation of the performance of the desalination and cooling system 100 at different temperatures of the evaporator 112 in the ECC system 102. The graph 2400A shows the GOR, which increases as the temperature of the evaporator 112 increases. The desalination and cooling system 100 attains a reasonable GOR of 0.7096, showcasing the efficiency of the standalone DCMD system under different conditions. The graph 2400B shows that the EUF increases with the rise in the temperature of the evaporator 112. The EUF, representative of the energy efficiency of the desalination and cooling system 100, peaks at 1.207 with the R718 refrigerant at a temperature of the evaporator 112 of 15° C. The graph 2400C shows a decrease in the freshwater production rate of the desalination and cooling system 100 with the rise in the temperature of the evaporator 112. Nevertheless, the desalination and cooling system 100 achieves a maximum productivity of 212.6 L/day. The graph 2400D shows the cooling effect produced by the desalination and cooling system 100, which increases as the temperature of the evaporator 112 rises. The highest cooling effect of 3557 W is achieved with the R718 refrigerant at a temperature of the evaporator 112 of 15° C.

It may be noted that integrating the DCMD system 104 with the ECC system 102 enhances energy efficiency of the DCMD system 104 in the desalination and cooling system 100 by over 70% when compared to the standalone DCMD system. This improvement is observed for the R718 refrigerant at different temperatures of the evaporator 112. The R718 refrigerant exhibits superior performance due to its ability to recover more waste heat from the condenser 116 of the ECC system 102. This increased recovery results in a higher transmembrane temperature in the DCMD system 104, leading to a higher driving force for vapor permeation, increased water flux, and consequently, improved energy efficiency of the desalination and cooling system 100.

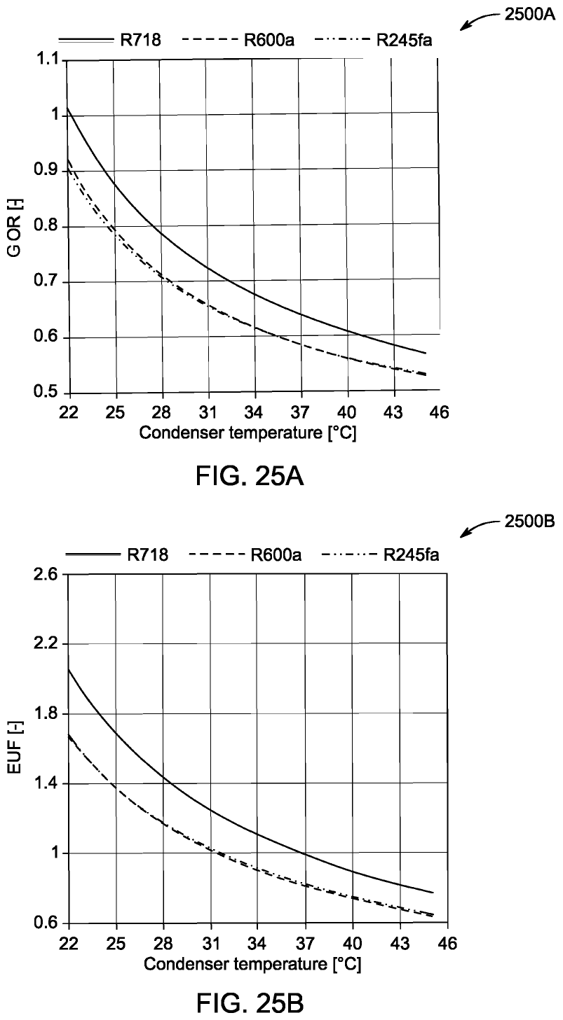

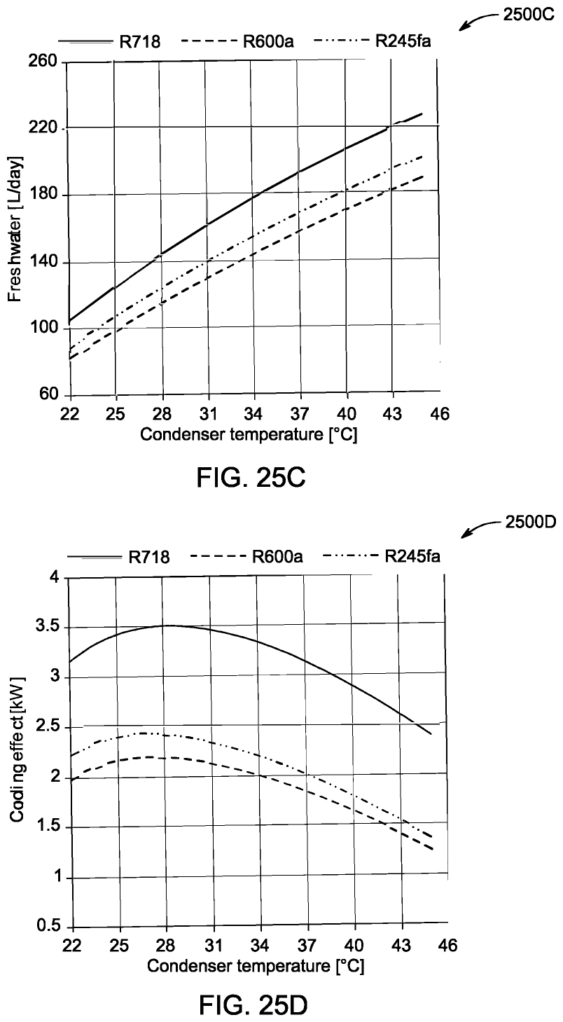

Referring to FIGS. 25A-25D, depicted are graphs 2500A-2500D illustrating the GOR, EUF, freshwater production, and cooling effect respectively, for evaluating the performance of the desalination and cooling system 100 at different temperatures of the condenser 116 in the ECC system 102. The graph 2500A shows the GOR of 0.9784, which decreases as the temperature of the condenser 116 rises, reflecting enhanced energy efficiency of the standalone DCMD system under different conditions. The graph 2500B shows that the EUF of 1.964, decreases with the increase in the temperature of the condenser 116, indicating a decrease in energy efficiency of the desalination and cooling system 100. The graph 2500C shows an increase in the freshwater production rate of the desalination and cooling system 100 with the rise in the temperature of the condenser 116. The desalination and cooling system 100 achieves a maximum productivity of 226.6 L/day, when using the R718 refrigerant. The graph 2500D shows the cooling effect produced by the desalination and cooling system 100, which initially increases and then decreases with the rise in the temperature of the condenser 116. The highest cooling effect, 3508 W, is achieved at a temperature of the condenser 116 of approximately 27° C. using the R718 refrigerant.

It may be noted that the integration of the DCMD system 104 with the ECC system 102 enhances energy efficiency of the DCMD system 104 in the desalination and cooling system 100 by over 100% when compared to the standalone DCMD system, as indicated by the highest recorded GOR and EUF values. This improvement is observed for the R718 refrigerant at different temperatures of the condenser 116. The R718 refrigerant demonstrates superior performance due to its capability to recover more waste heat from the condenser 116 of the ECC system 102. This increased recovery results in a higher transmembrane temperature in the DCMD system 104, leading to a higher driving force for vapor permeation, increased water flux, and consequently, improved energy efficiency of the desalination and cooling system 100.

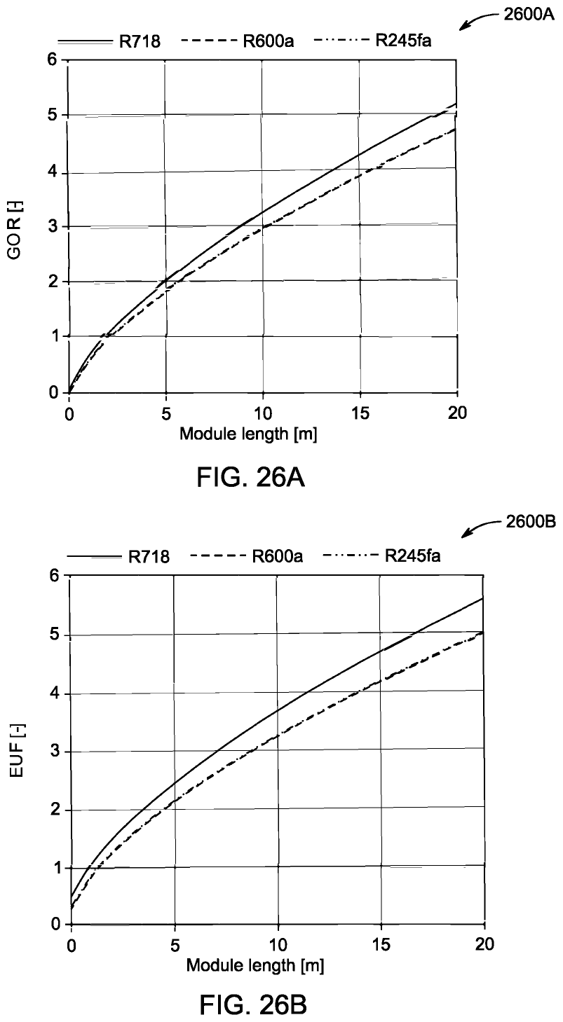

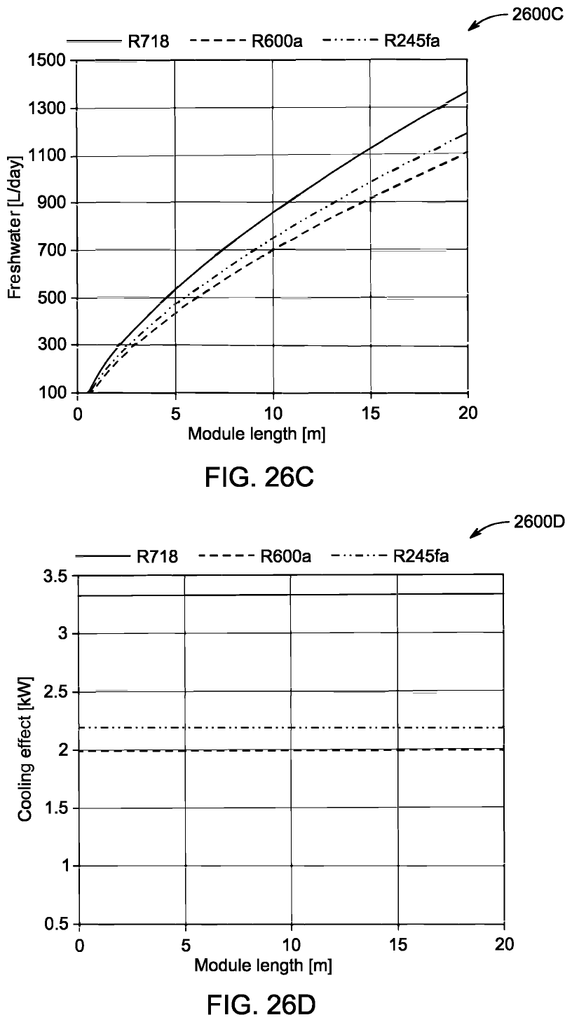

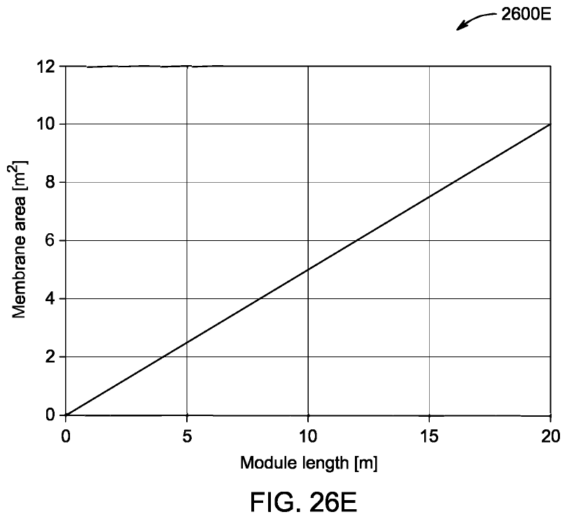

Referring to FIGS. 26A-26E, depicted are graphs 2600A-2600E illustrating the GOR, EUF, freshwater production, and cooling effect, respectively, for evaluating the performance of the desalination and cooling system 100 at different module length of the DCMD system 104. The graph 2600A shows the GOR, which improves with the rise in the module length of the DCMD system 104, reflecting enhanced energy efficiency under different conditions. The desalination and cooling system 100 reaches its highest GOR of 5.146 at a higher module length of 20 meters of the DCMD system 104 when using the R718 refrigerant. The graph 2600B shows the EUF, which also improves with the increase in the module length of the DCMD system 104. The EUF, representative of the energy efficiency of the desalination and cooling system 100, peaks at 5.569 at a higher module length of 20 m of the DCMD system 104 with the R718 refrigerant. The graph 2600C shows the freshwater production, which improves as the module length of the DCMD system 104 increases. The desalination and cooling system 100 achieves a maximum productivity of 1359 L/day, when using the R718 refrigerant. The graph 2600D shows the cooling effect produced by the desalination and cooling system 100, which remains constant as the module length of the DCMD system 104 increases. The desalination and cooling system 100 attains a substantial cooling effect of 3326 W. The graph 2600E shows that the increase in module length of the DCMD system 104 results in increased membrane 154 effective area for vapor permeation.

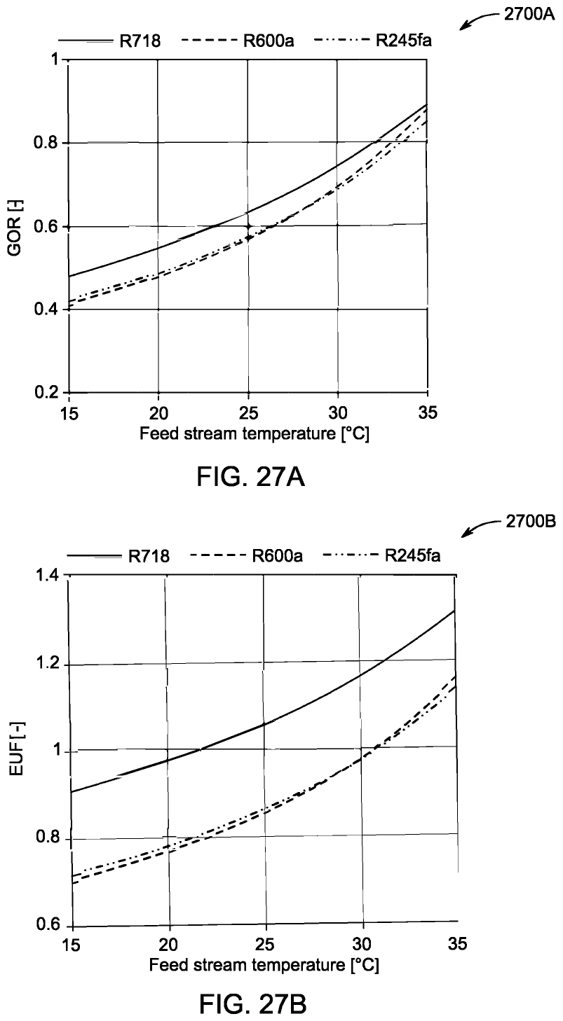

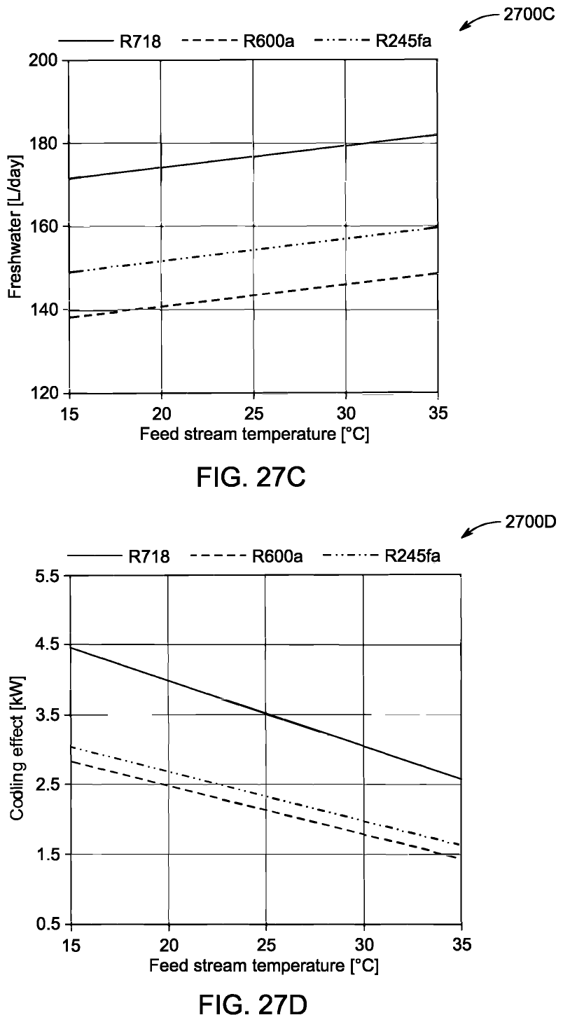

Referring to FIGS. 27A-27D, depicted are graphs 2700A-2700D illustrating the GOR, EUF, freshwater production, and cooling effect, respectively, for evaluating the performance of the desalination and cooling system 100 at increasing temperature of the feed stream 150. The graph 2700A shows the GOR, which increase as feed stream 150 temperature increases. The DCMD system 104 under different conditions attains a reasonable GOR, with the highest GOR of 0.8886 achieved at a temperature of 35° C. of the feed stream 150 using the R718 refrigerant. The graph 2700B shows that the EUF also increases with the increase in the temperature of the feed stream 150. The EUF, which represents the energy efficiency of the desalination and cooling system 100, peaks at 1.312 at a temperature of 35° C. of the feed stream with the R718 refrigerant. The graph 2700C shows a slight increase in the freshwater production rate of the desalination and cooling system 100 with the increase in the temperature of the feed stream 150. The desalination and cooling system 100 achieves a maximum productivity of 182 L/day at a temperature of 35° C. of the feed stream 150 using the R718 refrigerant. The graph 2700D shows the cooling effect produced by the desalination and cooling system 100, which decreases as the temperature of the feed stream 150 increases. The cooling effect is noted at 4444 W.

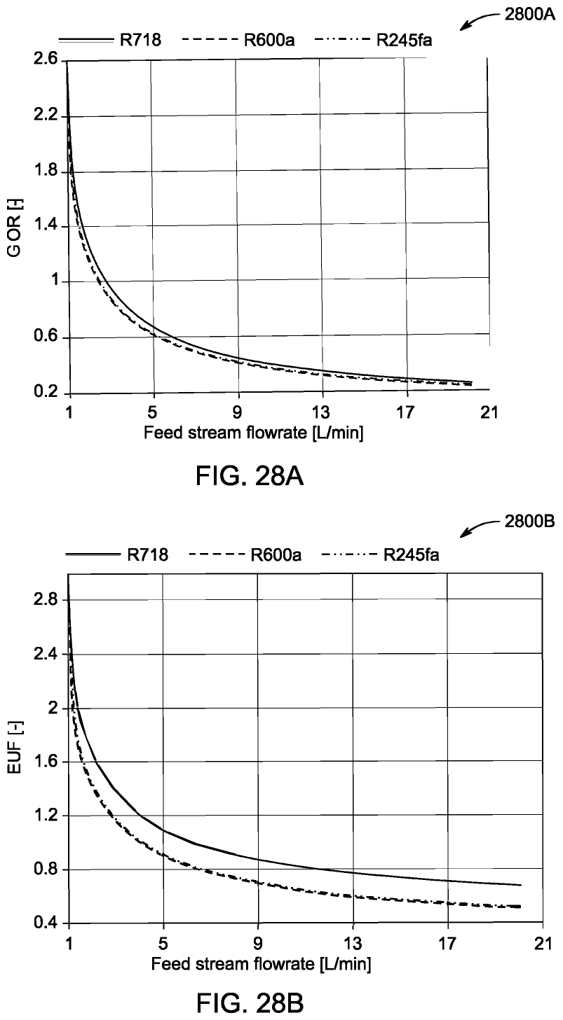

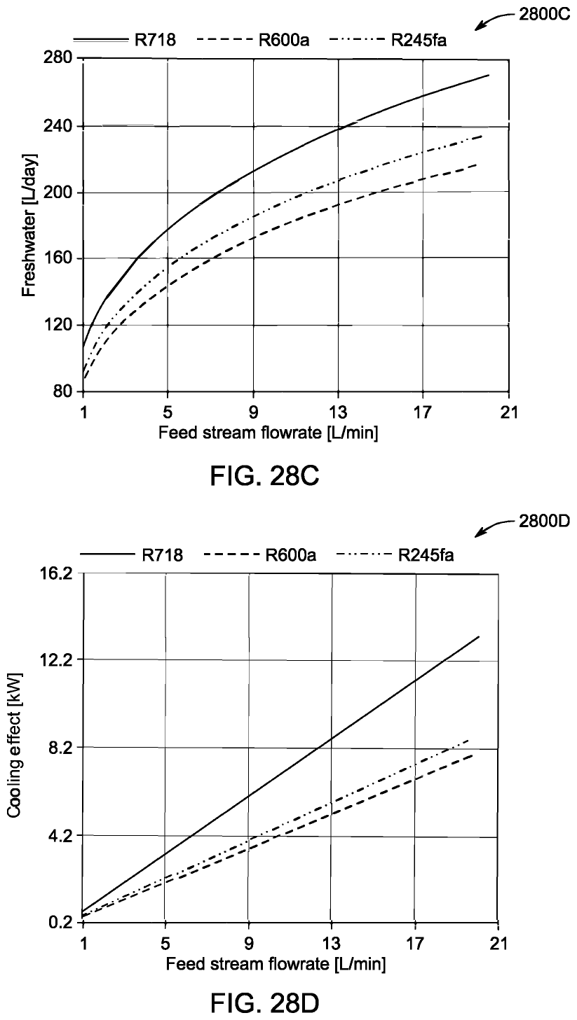

Referring to FIGS. 28A-28D, depicted are graphs 2800A-2800D illustrating the GOR, EUF, freshwater production, and cooling effect, respectively, for evaluating the performance of the desalination and cooling system 100 at different flowrates of the feed stream 150. The graph 2800A shows the GOR, which decreases as the flowrate of the feed stream 150 increases. Despite this decrease, the DCMD system 104 under different conditions still attains a reasonable GOR, with the highest GOR of 5.968 achieved at a flowrate of the feed stream 150 of 0.2 L/min using the R718 refrigerant. The graph 2800B shows that the EUF also decreases with the increase in the flowrate of the feed stream 150. The EUF, which represents the energy efficiency of the desalination and cooling system 100, peaks at 6.391 at a flowrate of the feed stream 150 of 0.2 L/min with the R718 refrigerant. The graph 2800C shows an increase in the freshwater production rate of the desalination and cooling system 100 with the increase in the flowrate of the feed stream 150. The desalination and cooling system 100 achieves a maximum productivity of 269 L/day at a flowrate of the feed stream 150 of 20 L/min using the R718 refrigerant. The graph 2800D shows the cooling effect produced by the desalination and cooling system 100, which increases as the flowrate of the feed stream 150 rises. The highest cooling effect, 13.3 kW, is achieved at a flowrate of the feed stream 150 of 20 L/min using the R718 refrigerant.

It may be noted that increasing the flowrate of the feed stream 150 from 0.2 L/min to 20 L/min using the R718 refrigerant leads to an increase in productivity of the desalination and cooling system 100 from 63 L/day to 269 L/day and the cooling load from 0.133 kW to 13.3 kW. However, the GOR and the EUF of the desalination and cooling system 100 decrease from 5.968 to 0.2545 and 6.391 to 0.6775, respectively. These changes can be attributed to the increased heat and mass transfer at higher flowrates of the feed stream 150, which enhances the cooling effect and freshwater productivity.

The desalination and cooling system 100-2400 (system) proposed in the present disclosure may find wide-ranging applications across various industries, as well as in specific processes requiring water treatment and temperature regulation. The system may be employed to desalinate seawater, thereby producing freshwater for various uses, including drinking, irrigation, and industrial processes. The system may be used for the purification of water used in textile manufacturing processes, aiding in the removal of dyes and other contaminants. The system may play a crucial role in the purification of water used in chemical synthesis and pharmaceutical production, helping maintain the purity of the products and adhere to stringent regulations. In the food industry, the system may be used in processes such as milk processing and fruit juice concentration, by aiding in the removal of impurities, ensuring the safety and quality of the products. The system may be used in biomedical applications such as the removal of pure water from blood and protein solutions, supporting research and development in the healthcare sector. The system may also be utilized in the separation of azeotropic aqueous mixtures, such as the separation of alcohol and water mixtures, enhancing the efficiency of industrial processes. The system may find applications in brine mining and in processes that require zero liquid discharge, contributing to resource conservation and environmental protection. The system may also be deployed in applications where high-temperature processing causes thermal degradation of the process flow, providing a solution that balances temperature regulation and efficient operation. More generally, the system may be used for the treatment of wastewater, reducing environmental impact, and aiding in sustainability efforts.

Numerous modifications and variations of the present disclosure are possible in light of the above teachings. It is therefore to be understood that within the scope of the appended claims, the present invention may be practiced otherwise than as specifically described herein.

1. A desalination and cooling system, comprising:
an ejector cooling cycle (ECC) system comprising;
a generator configured to generate a primary flow of a refrigerant,
an evaporator configured to provide cooling and provide a secondary flow of the refrigerant,
an ejector configured for the primary flow and the secondary flow to pass through to obtain a super-heated stream of the refrigerant, and
a condenser configured to cool the super-heated stream of the refrigerant; and
a direct contact membrane distillation (DCMD) system comprising;
a feed chamber configured to receive a feed stream comprising water,
a permeate chamber configured to receive water permeate, and
a membrane disposed between the feed chamber and the permeate chamber, the membrane configured to be in direct contact with the feed stream and the water permeate on opposing sides, the membrane comprising a plurality of pores configured to allow water vapors originating from the feed stream to pass from the feed chamber through the membrane to the permeate chamber,
wherein the ECC system and the DCMD system are connected at the condenser so that the feed stream is heated by the super-heated stream of the refrigerant at the condenser before entering the feed chamber.

2. The desalination and cooling system of claim 1, wherein the DCMD system further comprises a clean water chamber that is configured to receive permeated water vapors from the permeate chamber.

3. The desalination and cooling system of claim 2, wherein the evaporator is configured to provide cooling for the clean water chamber to condense the permeated water vapors therein.

4. The desalination and cooling system of claim 2, wherein the DCMD system further comprises an external cooling source that is configured to provide cooling for the clean water chamber to condense the permeated water vapors therein.

5. The desalination and cooling system of claim 2, wherein an outlet of the clean water chamber is connected to an inlet of the condenser so that the clean water chamber is configured to be cooled by the feed stream to condense the permeated water vapors while pre-heating the feed stream before the feed stream enters the condenser.

6. The desalination and cooling system of claim 1, wherein the ECC system further comprises a heater that is configured to provide heat for the generator to generate the primary flow of the refrigerant.

7. The desalination and cooling system of claim 6, wherein the heater is configured to further heat the feed stream after the condenser and before the feed chamber.

8. The desalination and cooling system of claim 1, wherein the ECC system further comprises a heater that is configured to further heat the super-heated stream of the refrigerant before the super-heated stream of the refrigerant enters the condenser.

9. The desalination and cooling system of claim 1, wherein the DCMD system is a multi-effect distillation system.

10. The desalination and cooling system of claim 1, wherein the ECC system further comprises a solar collector that is configured to provide heat for the generator to generate the primary flow of the refrigerant.

11. A desalination and cooling system, comprising:
an ejector cooling cycle (ECC) system comprising;
a generator configured to generate a primary flow of a refrigerant,
an evaporator configured to provide cooling and provide a secondary flow of the refrigerant,
an ejector configured for the primary flow and the secondary flow to pass through to obtain a super-heated stream of the refrigerant, and
a condenser configured to cool the super-heated stream of the refrigerant, the condenser comprising a wall separating a hot medium compartment and a cold medium compartment, the hot medium compartment configured to receive the super-heated stream of the refrigerant; and
a direct contact membrane distillation (DCMD) system comprising;
a permeate chamber configured to receive water permeate,
the cold medium compartment of the condenser of the ECC system configured to receive a feed stream comprising water, and
a membrane disposed between the cold medium compartment and the permeate chamber, the membrane configured to be in direct contact with the feed stream and the water permeate on opposing sides, the membrane comprising a plurality of pores configured to allow water vapors to pass from the cold medium compartment through the membrane to the permeate chamber,
wherein the ECC system and the DCMD system are connected at the condenser so that the feed stream, in the cold medium compartment of the condenser, is heated by the super-heated stream of the refrigerant to generate the water vapors.

12. The desalination and cooling system of claim 11, further comprising an enclosure that houses the hot medium compartment, the cold medium compartment, the membrane and the permeate chamber.

13. The desalination and cooling system of claim 12, wherein the hot medium compartment, the cold medium compartment, the membrane and the permeate chamber are arranged in succession in the enclosure.

14. The desalination and cooling system of claim 11, wherein:
the generator, the ejector and the condenser are configured to define a power cycle of the ECC system, and
the evaporator, the ejector and the condenser are configured to define a refrigeration cycle of the ECC system.

15. The desalination and cooling system of claim 11, wherein the DCMD system further comprises a clean water chamber that is configured to receive permeated water vapors from the permeate chamber.

16. The desalination and cooling system of claim 15, wherein the evaporator is configured to provide cooling for the clean water chamber to condense the permeated water vapors therein.

17. The desalination and cooling system of claim 15, wherein the DCMD system further comprises an external cooling source that is configured to provide cooling for the clean water chamber to condense the permeated water vapors therein.

18. The desalination and cooling system of claim 15, wherein an outlet of the clean water chamber is connected to an inlet of the condenser so that the clean water chamber is configured to be cooled by the feed stream to condense the permeated water vapors while pre-heating the feed stream before the feed stream enters the condenser.

19. The desalination and cooling system of claim 11, wherein the ECC system further comprises a heater that is configured to provide heat for the generator to generate the primary flow of the refrigerant.

20. The desalination and cooling system of claim 11, wherein the permeate chamber, the membrane, the cold medium compartment and the hot medium compartment are cylindrical and concentrical and are arranged in succession along a radial direction.
